(19) United States
(12) Patent Application Publication
(10) Pub. No.: US 2024/0152820 A1
(43) Pub. Date: May 9, 2024

(54) ADAPTIVE LEARNING IN DISTRIBUTION SHIFT FOR RAN AI/ML MODELS

(71) Applicant: Nokia Solutions and Networks Oy, Espoo (FI)

(72) Inventors: Vaibhav SINGH, Bangalore (IN); Anand BEDEKAR, Glenview, IL (US); Shivanand KADADI, Bangalore (IN); Parijat BHATTACHARJEE, Bangalore (IN)

(21) Appl. No.: 18/548,509

(22) PCT Filed: Mar. 23, 2021
(86) PCT No.: PCT/US2021/023583

§ 371 Date: Aug. 31, 2023

(51) Int. Cl. G06N 20/00

(52) U.S. Cl. CPC G06N 20/00

(57) ABSTRACT

An apparatus includes circuitry configured to: receive a request from a radio access network algorithm to determine whether there is a distribution shift related to a temporal characteristic of a cell of a communication network; request data from a radio access network node or a controller platform related to the temporal characteristic; receive the requested data related to the cell from the radio access network node or the controller platform; determine whether there is a distribution shift related to the temporal characteristic; in response to determining that there is a distribution shift, select a learning type for an update to a model; and update the model such that, when the model is provided to an inference server, causes the radio access network algorithm to use the updated model to perform at least one action to optimize the performance of the radio access network node or other radio access network node.

### TECHNICAL FIELD

The examples and non-limiting embodiments relate generally to communications, and more particularly, to adaptive learning in distribution shift for RAN AI/ML models.

### BACKGROUND

It is known to perform radio resource management (RRM) within a communication network.

### SUMMARY

In accordance with an aspect, an apparatus includes at least one processor; and at least one non-transitory memory including computer program code; wherein the at least one memory and the computer program code are configured to, with the at least one processor, cause the apparatus at least to: receive a request from a radio access network algorithm to determine whether there is a distribution shift related to at least one temporal characteristic of at least one cell of a communication network; request data from a radio access network node or a controller platform related to the at least one temporal characteristic of the at least one cell, based on the request from the radio access network algorithm; receive the requested data related to the at least one cell from the radio access network node or the controller platform; determine whether there is a distribution shift related to the at least one temporal characteristic of the at least one cell, based on the received data; in response to determining that there is a distribution shift, select a learning type for an update to a model; and based on the selected learning type, update the model such that, when the model is provided to an inference server, causes the radio access network algorithm to use the updated model to perform at least one action to optimize the performance of the radio access network node or at least one other radio access network node.

In accordance with an aspect, an apparatus includes at least one processor; and at least one non-transitory memory including computer program code; wherein the at least one memory and the computer program code are configured to, with the at least one processor, cause the apparatus at least to: receive a request for data related to at least one temporal characteristic of at least one cell of a communication network from a radio intelligent controller; and provide the requested data from a radio access network node or a controller platform related to the at least one cell to the radio intelligent controller; wherein the provided data is configured to be used in a determination of whether to update a model associated with an action of the radio access network node or at least one other radio access network node.

In accordance with an aspect, an apparatus includes at least one processor; and at least one non-transitory memory including computer program code; wherein the at least one memory and the computer program code are configured to, with the at least one processor, cause the apparatus at least to: send a request from a radio access network algorithm, the request related to a determination of whether there is a distribution shift related to at least one temporal characteristic of at least one cell of a communication network; and perform at least one action using a model that has been updated to optimize the performance of a radio access network node or at least one other radio access network node, in response a determination that there is a distribution shift related to the at least one temporal characteristic of the at least one cell of the communication network.

In accordance with an aspect, an apparatus includes means for receiving a request from a radio access network algorithm to determine whether there is a distribution shift related to at least one temporal characteristic of at least one cell of a communication network; means for requesting data from a radio access network node or a controller platform related to the at least one temporal characteristic of the at least one cell, based on the request from the radio access network algorithm; means for receiving the requested data related to the at least one cell from the radio access network node or the controller platform; means for determining whether there is a distribution shift related to the at least one temporal characteristic of the at least one cell, based on the received data; means for, in response to determining that there is a distribution shift, selecting a learning type for an update to a model; and means for, based on the selected learning type, updating the model such that, when the model is provided to an inference server, causes the radio access network algorithm to use the updated model to perform at least one action to optimize the performance of the radio access network node or at least one other radio access network node.

In accordance with an aspect, an apparatus includes means for receiving a request for data related to at least one temporal characteristic of at least one cell of a communication network from a radio intelligent controller; and means for providing the requested data from a radio access network node or a controller platform related to the at least one cell to the radio intelligent controller; wherein the provided data is configured to be used in a determination of whether to update a model associated with an action of the radio access network node or at least one other radio access network node.

In accordance with an aspect, an apparatus includes means for sending a request from a radio access network algorithm, the request related to a determination of whether there is a distribution shift related to at least one temporal characteristic of at least one cell of a communication network; and means for performing at least one action using a model that has been updated to optimize the performance of a radio access network node or at least one other radio access network node, in response a determination that there is a distribution shift related to the at least one temporal characteristic of the at least one cell of the communication network.

In accordance with an aspect, a method includes receiving a request from a radio access network algorithm to determine whether there is a distribution shift related to at least one temporal characteristic of at least one cell of a communication network; requesting data from a radio access network node or a controller platform related to the at least one temporal characteristic of the at least one cell, based on the request from the radio access network algorithm; receiving the requested data related to the at least one cell from the radio access network node or the controller platform; determining whether there is a distribution shift related to the at least one temporal characteristic of the at least one cell, based on the received data; in response to determining that there is a distribution shift, selecting a learning type for an update to a model; and based on the selected learning type, updating the model such that, when the model is provided to an inference server, causes the radio access network algorithm to use the updated model to perform at least one action to optimize the performance of the radio access network node or at least one other radio access network node.

In accordance with an aspect, a method includes receiving a request for data related to at least one temporal characteristic of at least one cell of a communication network from a radio intelligent controller; and providing the requested data from a radio access network node or a controller platform related to the at least one cell to the radio intelligent controller; wherein the provided data is configured to be used in a determination of whether to update a model associated with an action of the radio access network node or at least one other radio access network node.

In accordance with an aspect, a method includes sending a request from a radio access network algorithm, the request related to a determination of whether there is a distribution shift related to at least one temporal characteristic of at least one cell of a communication network; and performing at least one action using a model that has been updated to optimize the performance of a radio access network node or at least one other radio access network node, in response a determination that there is a distribution shift related to the at least one temporal characteristic of the at least one cell of the communication network.

In accordance with an aspect, a non-transitory program storage device readable by a machine, tangibly embodying a program of instructions executable by the machine for performing operations is provided, the operations comprising: receiving a request from a radio access network algorithm to determine whether there is a distribution shift related to at least one temporal characteristic of at least one cell of a communication network; requesting data from a radio access network node or a controller platform related to the at least one temporal characteristic of the at least one cell, based on the request from the radio access network algorithm; receiving the requested data related to the at least one cell from the radio access network node or the controller platform; determining whether there is a distribution shift related to the at least one temporal characteristic of the at least one cell, based on the received data; in response to determining that there is a distribution shift, selecting a learning type for an update to a model; and based on the selected learning type, updating the model such that, when the model is provided to an inference server, causes the radio access network algorithm to use the updated model to perform at least one action to optimize the performance of the radio access network node or at least one other radio access network node.

In accordance with an aspect, a non-transitory program storage device readable by a machine, tangibly embodying a program of instructions executable by the machine for performing operations is provided, the operations comprising: receiving a request for data related to at least one temporal characteristic of at least one cell of a communication network from a radio intelligent controller; and providing the requested data from a radio access network node or a controller platform related to the at least one cell to the radio intelligent controller; wherein the provided data is configured to be used in a determination of whether to update a model associated with an action of the radio access network node or at least one other radio access network node.

In accordance with an aspect, a non-transitory program storage device readable by a machine, tangibly embodying a program of instructions executable by the machine for performing operations, the operations comprising: sending a request from a radio access network algorithm, the request related to a determination of whether there is a distribution shift related to at least one temporal characteristic of at least one cell of a communication network; and performing at least one action using a model that has been updated to optimize the performance of a radio access network node or at least one other radio access network node, in response a determination that there is a distribution shift related to the at least one temporal characteristic of the at least one cell of the communication network.

### BRIEF DESCRIPTION OF THE DRAWINGS

The foregoing aspects and other features are explained in the following description, taken in connection with the accompanying drawings.

FIGS. 1A and 1B are block diagrams of possible and non-limiting exemplary systems in which the exemplary embodiments may be practiced.

FIGS. 1C-1, 1C-2, and 1D are block diagrams of exemplary configurations of the non-real time (non-RT) and near real-time (near-RT) radio intelligent controllers (RICs) from FIG. 1A.

FIG. 2 illustrates a system perspective of the described solution.

FIG. 3 shows an example oRAN architecture of a RIC.

FIG. 4A is a histogram showing cellular network load during the first half of a week.

FIG. 4B is a histogram showing cellular network load during the second half of the week.

FIG. 5 is a block diagram showing integration of distribution shift learning within a communication system.

FIG. 6 shows an example distribution shift learning architecture.

FIG. 7 shows an example message flow for distribution shift learning.

FIG. 8 is a flowchart for distributed shift learning for a particular RAN optimization algorithm.

FIG. 9 depicts an incremental learning solution for a model update.

FIG. 10 shows a general distribution shift solution framework.

FIG. 11A shows a Type A1 batch learning single model variation.

FIG. 11B shows a Type A2 batch learning single model variation.

FIG. 11C shows a Type A3 batch learning single model variation.

FIG. 12 shows Type B model ensemble learning.

FIG. 13 is Table 1, which provides a distribution shift learning variations evaluation for load prediction.

FIG. 14 shows an example dual hybrid learning model.

FIG. 15 shows selection of a distribution shift learning type.

FIG. 16 is an example apparatus to implement adaptive learning in distribution shift for RAN AI/ML models, based on the examples described herein.

FIG. 17 is a method to implement adaptive learning in distribution shift for RAN AI/ML models, based on the examples described herein.

FIG. 18 is another method to implement adaptive learning in distribution shift for RAN AI/ML models, based on the examples described herein.

FIG. 19 is another method to implement adaptive learning in distribution shift for RAN AI/ML models, based on the examples described herein.

### DETAILED DESCRIPTION OF EXAMPLE EMBODIMENTS

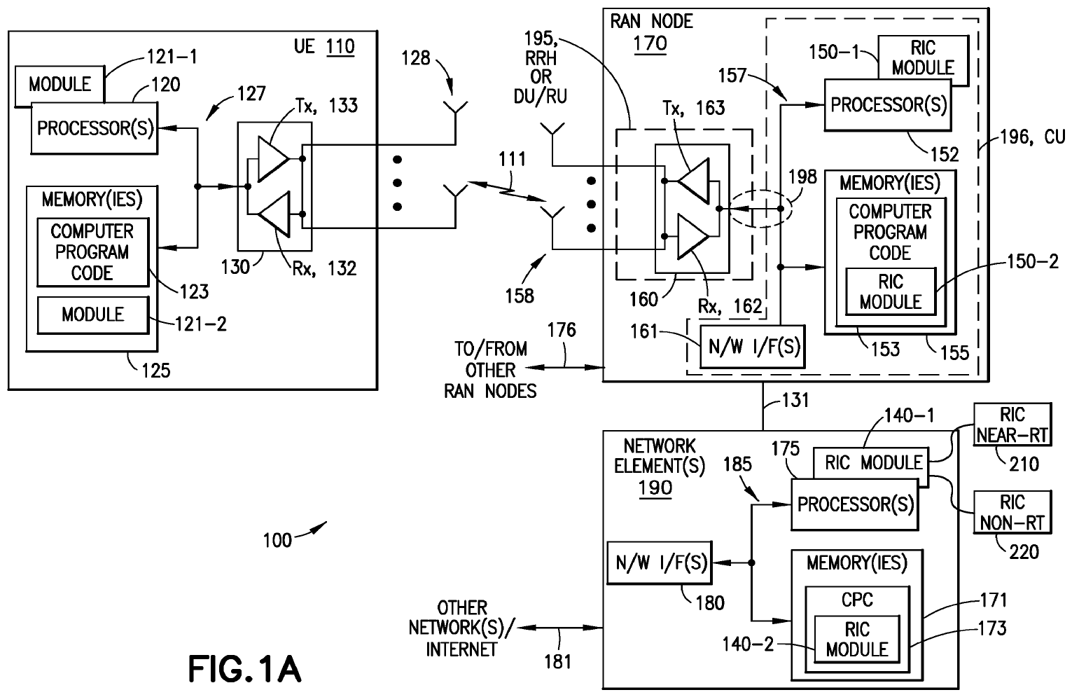

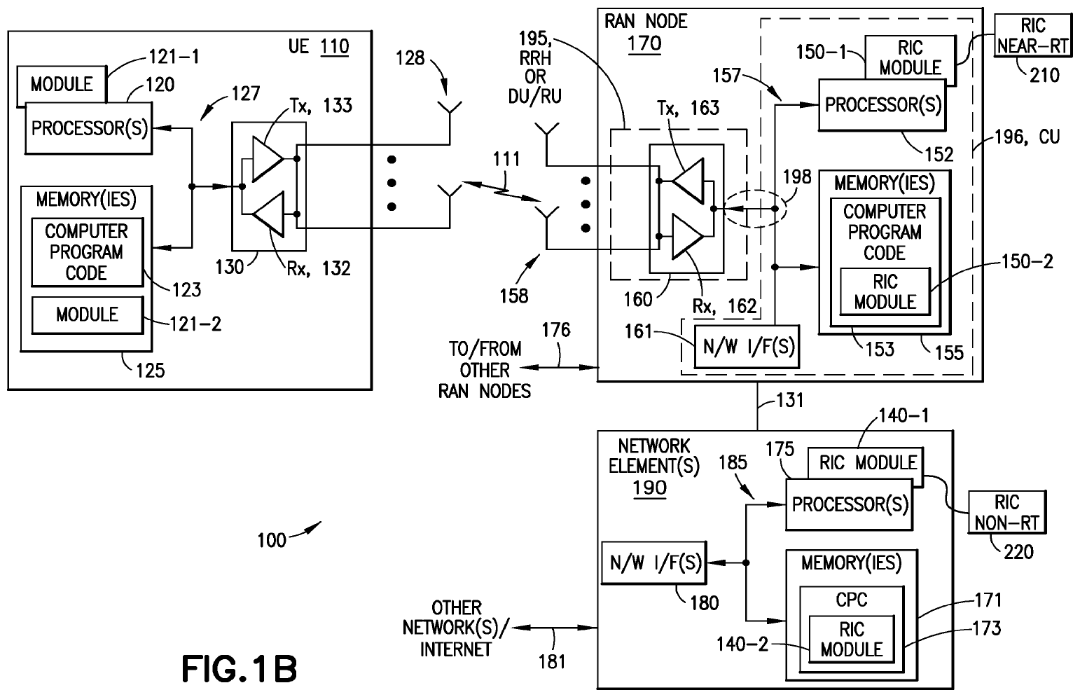

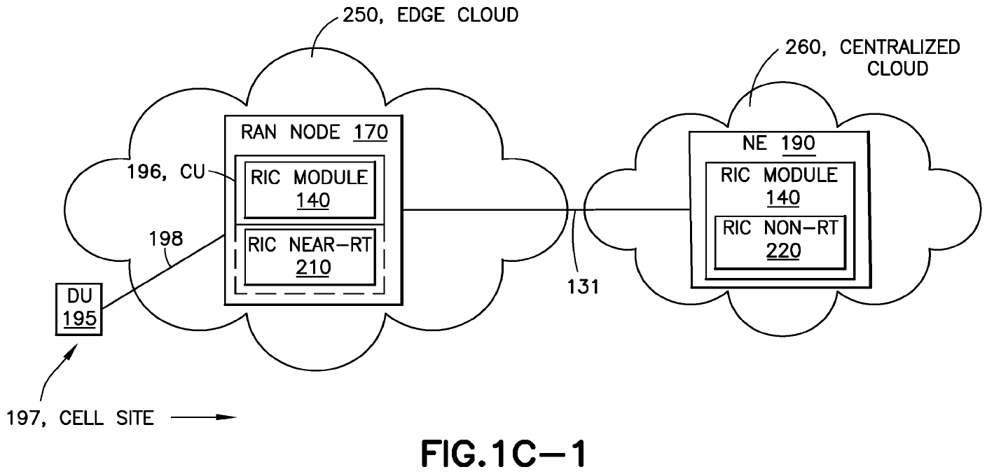

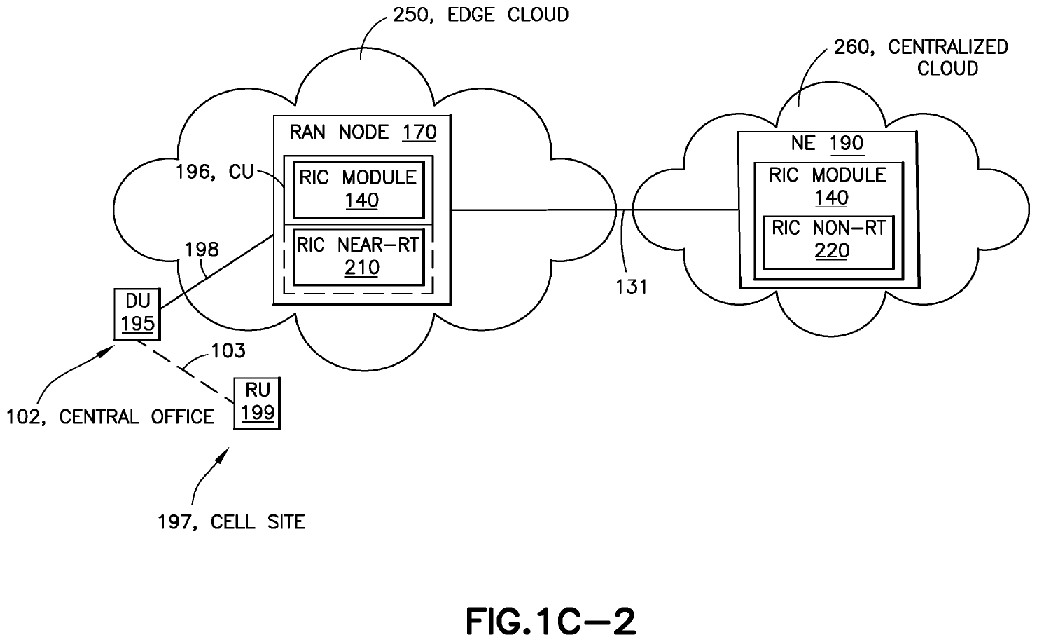

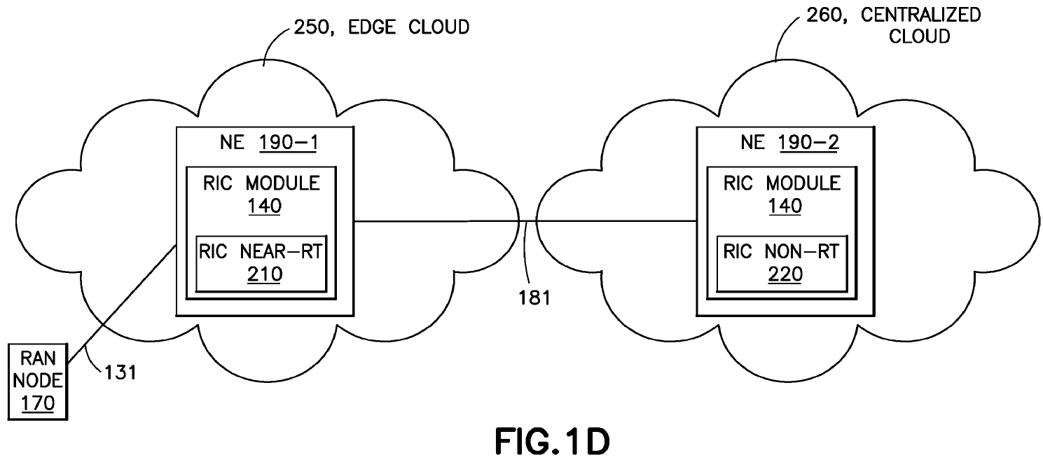

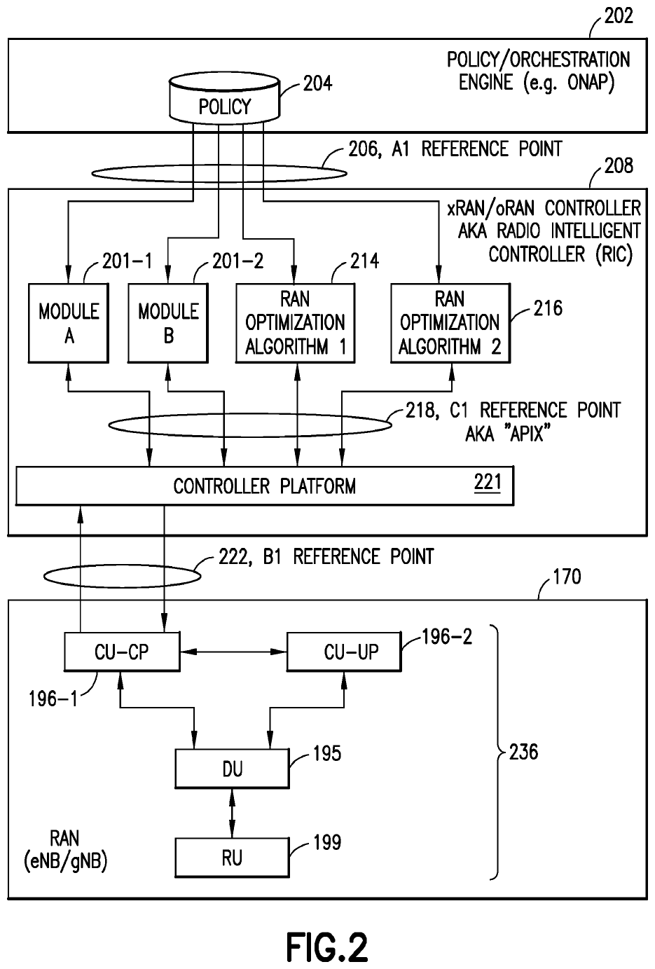

Turning to FIG. 1A, this figure shows a block diagram of one possible and non-limiting exemplary system in which the exemplary embodiments may be practiced. In FIG. 1A, a user equipment (UE) 110, a radio access network (RAN) node 170, and one or more network element(s) (NE(s)) 190 are illustrated. FIG. 1A illustrates possible configurations of RICs known as a near-real time (near-RT) RIC 210 and a non-RT RIC 220. These configurations are described in more detail after the elements in FIG. 1A are introduced and also in reference to FIGS. 1B, 1C-1, 1C-2, and 1D.

In FIG. 1A, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 121, comprising one of or both parts 121-1 and/or 121-2, which may be implemented in a number of ways. The module 121 may be implemented in hardware as module 121-1, such as being implemented as part of the one or more processors 120. The module 121-1 may be implemented also as an integrated circuit or through other hardware such as a programmable gate array. In another example, the module 121 may be implemented as module 121-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111. The modules 121-1 and 121-2 may be configured to implement the functionality of the UE as described herein.

The RAN node 170 in this example is a base station that provides access by wireless devices such as the UE 110 to the wireless network 100. The RAN node 170 may be, for instance, a base station for 5G, also called New Radio (NR). In 5G, the RAN node 170 may be a NG-RAN node, which is defined as either a gNB or an ng-eNB. The gNB 170 is a node providing NR user plane and control plane protocol terminations towards the UE, and connected via the NG interface 131 to the 5GC (e.g., the network element(s) 190). The ng-eNB is a node providing E-UTRA user plane and control plane protocol terminations towards the UE, and connected via the NG interface 131 to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting RRC, SDAP and PDCP protocols of the gNB or RRC and PDCP protocols of the en-gNB that control the operation of one or more gNB-DUs 195. The gNB-CU 196 terminates the F1 interface connected with the gNB-DU 195. The F1 interface is illustrated as reference 198, although reference 198 also illustrates connection between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell is typically supported by only one gNB-DU 195. The gNB-DU 195 terminates the F1 interface 198 connected with the gNB-CU 196. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memory(ies) 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a RIC module 150, comprising one of or both parts 150-1 and/or 150-2, which may be implemented in a number of ways. The RIC module 150 may be implemented in hardware as RIC module 150-1, such as being implemented as part of the one or more processors 152. The RIC module 150-1 may be implemented also as an integrated circuit or through other hardware such as a programmable gate array. In another example, the RIC module 150 may be implemented as RIC module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, e.g., fiber optic cable or other suitable network connection to connect the other elements (e.g., a central unit (CU), gNB-CU 196) of the RAN node 170 to the RRH/DU 195. Reference 198 also indicates those suitable network connection(s).

It is noted that description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element (NE) (or elements, NE(s)) 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)) and/or radio resource management (RRM) functions. Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code (CPC) 173. The one or more memories 171 and the computer program code 173 are configured to, with the one or more processors 175, cause the network element 190 to perform one or more operations. The network element 190 includes a RIC module 140, comprising one of or both parts 140-1 and/or 140-2, which may be implemented in a number of ways. The RIC module 140 may be implemented in hardware as RIC module 140-1, such as being implemented as part of the one or more processors 175. The RIC module 140-1 may be implemented also as an integrated circuit or through other hardware such as a programmable gate array. In another example, the RIC module 140 may be implemented as RIC module 140-2, which is implemented as computer program code 173 and is executed by the one or more processors 175. In some examples, a single RIC could serve a large region covered by hundreds of base stations. The network element(s) 190 may be one or more network control elements (NCEs).

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. The UE 100 may also be a head mounted display that supports virtual reality, augmented reality, or mixed reality.

FIG. 1B is configured similar to FIG. 1A, except for the location of the near-RT RIC 210.

Possible Configurations of Radio Intelligent Controllers (RICs)

Possible configurations are shown of RICs known as a near-real time (near-RT) RIC 210 and a non-RT RIC 220 in FIGS. 1A, 1B, 1C-1, 1C-2, and 1D. There are a number of possibilities for the locations of the near-RT RIC 210 and the non-RT RIC 220.

One possible instantiation of RIC non-RT 220 and RIC near-RT 210 is these are entities separate from the RAN node 170. This is illustrated by FIG. 1A, where both the RIC near-RT 210 and the RIC non-RT 220 could be implemented by a single network element 190 or by multiple network elements 190.

However it is also possible that the RIC near-RT 210 functionality may be a part of the RAN node 170, in a couple of cases:
1) The RAN node itself may be composed of a centralized unit (CU) that may reside in the edge cloud, and so the RAN CU 196 and the RIC near-RT 210 would be at least collocated, and maybe even combined; or
2) The RIC near-RT 210 functionality may be possibly hosted inside a RAN node 170.

FIG. 1B illustrates that the RIC near-RT 210 may be implemented in the RAN node 170, e.g., combined with the RIC module 150 (e.g., as part of RIC module 150-1 as shown or RIC module 150-2 or some combination of those). In this example, the RIC non-RT 220 would be implemented in the network element 190, e.g., as part of the RIC module 140 (e.g., as part of RIC module 140-1 as shown or RIC module 140-2 or some combination of those).

FIG. 1C-1 illustrates a RAN node 170 in an edge cloud 250. The RAN node 170 includes a CU 196 that includes the RIC module 140 and, as a separate entity, the RIC near-RT 210. The separate RIC near-RT 210 could be implemented by the processor(s) 152 and memory(ies) 155 (and/or other circuitry) by the RAN node 170 or have its own, separate processor(s) and memories (and/or other circuitry). This is the collocation from (1) above. The combined aspect of (1) above is illustrated by the dashed line around the RIC near-RT 210, indicating the RIC near-RT 210 is also part of the CU 196. FIG. 1C-1 also illustrates the RIC non-RT 220 may be implemented as part of the RIC module 140 in a network element 190 that is in a centralized cloud 260. In the example of FIG. 1C-1, the DU 195 are typically located at the cell site 197 and may include the RU.

The edge cloud 250 may be viewed as a “hosting location”, e.g., a kind of data center. Multiple elements may be hosted there, such as the CU, RIC, core network elements such as MME/SGW or NGC, and yet other functions like MEC (mobile edge computing) platforms, and the like.

In the example of FIG. 1C-2, the DU 195 could also be located in a central office 102, in so-called Centralized-RAN configurations. In these configurations, the DU 195 is at the central office 102, but the RU 199 is at the cell site 197, and the DU 195 is interconnected to the RU 199 typically by a fiber network 103 or other suitable network (the so-called “Fronthaul”).

It is also possible the RIC near-RT 210 may be located at an edge cloud, at some relatively small latency from the RAN node (such as 30-100 ms), while the RIC non-RT 220 may be at a greater latency likely in a centralized cloud. This is illustrated by FIG. 1D, where network element 190-1 is located at an edge cloud 250 and comprises the RIC module 140 which incorporates the RIC near-RT 210. The RIC non-RT 220, meanwhile, is implemented in this example in the RIC module 140 of another NCE 190-2 in the centralized cloud 260.

Accordingly, UE 110, RAN node 170, network element(s) 190, (and associated memories, computer program code and modules), edge cloud 250, and/or centralized cloud 260 may be configured to implement the methods described herein, including a method to implement adaptive learning in distribution shift for RAN AI/ML models.

Having thus introduced suitable but non-limiting technical contexts for the practice of the exemplary embodiments described herein, the exemplary embodiments are now described with greater specificity.

The oRAN Alliance seeks to develop an architecture based on open APIs that allow radio resource management (RRM) algorithms and RAN optimization algorithms to be hosted on an open platform called an xRAN controller or Radio Intelligent Controller (RIC) so as to interact with and guide the behavior of the RAN. The Applicant of the instant disclosure is making strategic plans to develop its own Radio Intelligent Controller (RIC).

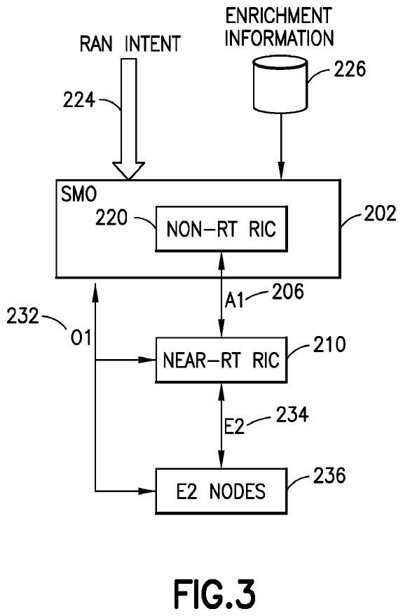

With reference to FIG. 2, a concept in the architecture of the xRAN controller/RIC 208 is that the various RRM/optimization algorithms (214 and 216) can be instantiated as services on top of an underlying controller platform 221. The services (214 and 216) can interact with the platform 221 by means of an “API X” 218, also sometimes referred to as reference point “C1” 218. This allows the RIC 208 to be an open platform that can host an ecosystem of applications. The underlying RIC platform can provide the ability to interface to the RAN by means of a reference point or interface B1 222 (sometimes known as E2, such as E2 234 in FIG. 3), in order to receive information from the RAN as well as to communicate information or control actions to the RAN. The RIC/Controller platform 208/221 can provide various underlying facilities such as analytics and machine learning which may be used by various algorithms living on top of the RIC platform 208.

With respect to the examples described herein, an approach is taken that some of these services instantiated on the controller platform 221 may be common programmable modules (201-1 and 201-2) that can be invoked by multiple RRM/Optimization Algorithms (214, 216). That is, these modules/interfaces (201-1, 201-2) may be considered as common building blocks in the operation of multiple of the RRM/Optimization Algorithms (214, 216).

One such module 201 is described herein (module A 201-1 and module B 201-2 are particular instantiations of module 201), that involves a programmable API that allows the module 201 to suitably interact with multiple such RRM/Optimization algorithms/services (214, 216). In the xRAN/oRAN architecture, the module's API would map to API X/Reference point C1 218 (refer to FIG. 2), if the module is instantiated on RIC-near-RT 210 (refer to FIG. 3). It could also be part of a RIC product, with published APIs that allow provided modules (such as module A 201-1 and module B 201-2) to be accessed by 3rd party or operator-developed Algorithms/Optimization services (such as RAN optimization algorithm 1 214 and RAN optimization algorithm 2 216) on top of the RIC platform 208.

Thus FIG. 2 illustrates a system perspective of the described solution. The proposed module can be instantiated on the oRAN RIC 208 shown in FIG. 2. Further, the RIC 208 may comprise the non-RT RIC part 220 and the near-RT RIC part 210 as shown in FIG. 3 (which shows a perspective of RIC 208 from oRAN standards). The module 201 described herein as a solution would be part of RIC-non-RT 220 from the oRAN specification point of view, as machine learning training-related functions are described as being instantiated on RIC-non-RT 220 in the ORAN specifications. From a product perspective, based on the examples described herein, it is possible to develop a RIC 208 comprising module 201 that does both RIC non-RT 220 and RIC-near-RT 210 functions, and the examples described herein may include training-related functionality in RIC-near-RT 210. Therefore, in FIG. 2, the module 201 (either or both of 201-1 and/or 201-2) of the RIC 208 can be instantiated in either the near-RT RIC 210 or non-RT RIC 220.

As is further shown in FIG. 2, a policy/orchestration engine (e.g. ONAP) 202 comprises a policy database/engine 204 that determines policies of the various aspects of the xRAN/oRAN controller aka radio intelligent controller (RIC) 208. As shown in FIG. 2, the policy database/engine 204 provides a policy for module A 201-1, module B 201-1, RAN optimization algorithm 1 214 and RAN optimization algorithm 2 216 via A1 reference point 206. One or both of module A 201-1 and/or module B 201-2 may implement the functionality of the distribution shift learning module 201 as described herein.

With reference to FIG. 2 and FIG. 3, the RAN node 170 includes several E2 nodes 236, namely CU-CP 196-1, CU-UP 196-2, DU 195, and RU 199. The controller platform 221 of the RIC 208 provides and receives control information to the CU-CP 196-1 of the RAN node 170 via B1 reference point 222.

FIG. 3 further shows RAN intent 224 and enrichment information 226 being provided to the SMO 202. The SMO 202 comprises the non-RT RIC 220 which communicates with the near-RT RIC 210 via the A1 interface 206. The SMO 202 communicates with the near-RT RIC 210 and E2 nodes 236 via the O1 interface 232, and the near-RT RIC 210 communicates with the E2 nodes 236 via the E2 interface 234.

Multiple RRM/RAN optimization algorithms have been analyzed by the instant assignee of this disclosure, which could be instantiated as services on a controller platform such as the xRAN Controller aka Radio Intelligent Controller (RIC) 208. These RRM/RAN optimization algorithms include CQI/PUCCH optimization, inter-frequency load-balancing, admission control optimization, carrier aggregation S-cell selection, etc. The terms “RAN algorithm”, “RAN/RRM optimization algorithm”, “RRM/RAN optimization algorithm service”, “RAN optimization algorithm module” and the like may be used interchangeably to refer to either a certain algorithm or a module or service or functional entity that performs a certain algorithm that is intended to optimize or enhance the performance of a radio access network (RAN) or a radio access network node (RAN node, such as RAN node 170) or a radio resource management (RRM) function in a RAN or RAN node.

The algorithms (such as items 214, 216, and/or 217) try to optimize the performance of the RAN, for example by adapting various settings or thresholds or the calculation of certain metrics. Many of these algorithms use machine learning models for example neural networks, reinforcement learning, random forest etc. for adapting these thresholds or calculation of certain metrics, based on cell characteristics. These models are trained on data collected from the RAN.

In the case of a RRM/RAN optimization/algorithm service (214, 216, or 217) for CQI optimization, the RAN optimization algorithm module/service (214, 216, or 217) can use an inference result from an ML model to obtain a prediction of the throughput that could be achievable if the CQI reporting interval were set to a value within a suitable range, and performs an action to update the CQI reporting interval for users of a RAN node (170) to a value that provides improved or optimized throughput.

The RRM/RAN optimization/algorithm service (214, 216, or 217) may be used to optimize other aspects of the RAN as well, including at least i) intra/inter-frequency load-balancing (handing off users, or modifying one or more measurement offsets that change the signal levels at which handovers are to be triggered), ii) admission control (changing a threshold or applying an offset to a threshold based on a function of signal or load/traffic level for admitting users to a network), and iii) CA Scell selection (changing a threshold or applying an offset to a threshold based on a function of signal quality or load/traffic level for selecting an Scell).

In the case of a RRM/RAN optimization/algorithm service for intra/inter-frequency load balancing, the RAN optimization algorithm module/service (214, 216, or 217) can use an inference result from an ML model to obtain a prediction of the utility function (which is a function of user/cell throughput and call drops) that could be achievable based on measurement offsets that change signal levels at which handovers are triggered, cell load and performs an action to update the measurement offsets for users of a RAN node to a value that provides an improved or optimized utility function.

In the case of a RRM/RAN optimization/algorithm service for admission control, the RAN optimization algorithm module/service (214, 216, or 217) can use an inference result from an ML model to obtain a utility function of call drops and call blocking based on certain admission control threshold values, load and channel conditions in the cell, and performs an action to update the threshold for users of a RAN node to a value that provides an improved utility function.

In the case of a RRM/RAN optimization/algorithm service for carrier aggregation (CA) Scell selection, the RAN optimization algorithm module/service (214, 216, or 217) can use an inference result from an ML model to obtain a prediction of the throughput/spectral efficiency that could be achievable based on the CA threshold, channel conditions and load, and performs an action to update the threshold for users of a RAN node to a value that provides improved or optimized throughput.

The characteristics of cells/regions in which these ML models are deployed could change with time due to variables/factors hidden from the ML model training. Though temporal characteristics of cell KPIs, for example, PRB usage, number of users, mobility of users, SINR, trend, peakiness of load, higher moments of load time series etc. vary in a network, they also vary at different times of a day in a cell.

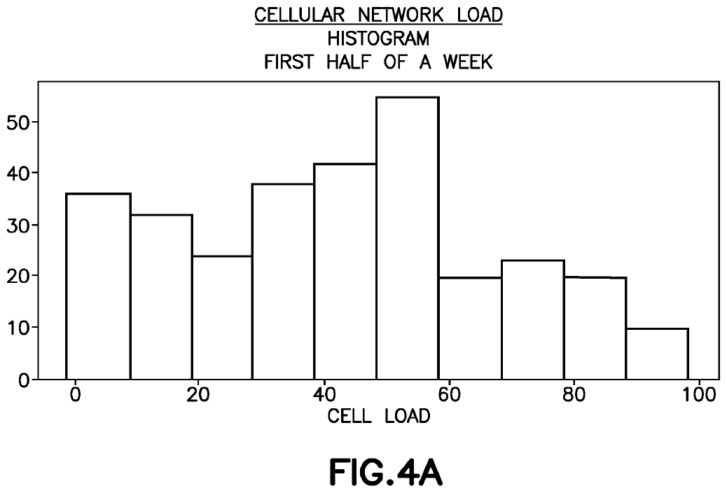

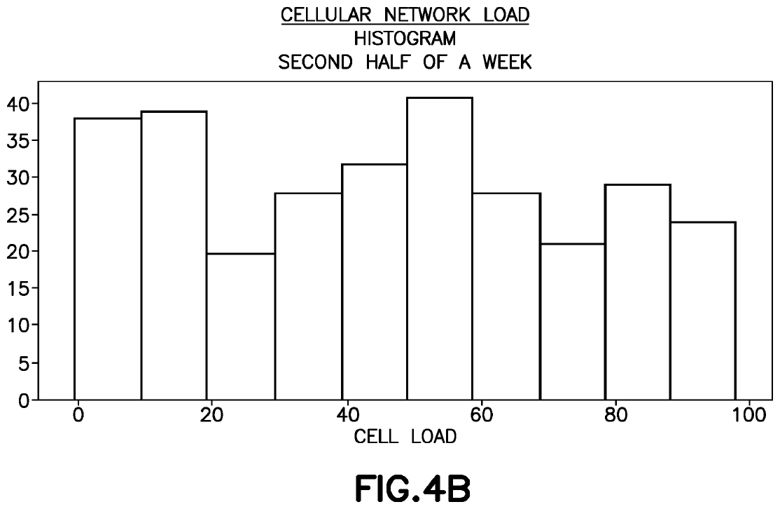

The ML models deployed on field, earlier trained on offline field data or simulation data may not take the features of drift into account, and become obsolete as the field data characteristics/distribution change/changes with time and performance of the model could degrade with time. Therefore, there is need to detect such a distribution shift and update the ML models based on the distribution shift observed on field (shown in FIG. 4A and FIG. 4B for a cell).

Each RAN optimization algorithm may have its own criterion to check if there is distribution shift of field data and requirements to update the ML model. For example in some cases an RRM/Optimization algorithm ML model may be trained on a particular set of data KPIs with respect to one or more other RRM optimization algorithm ML models, for example one model may be using the number of RRC connected users as a model feature and another algorithm may be using DL PRB usage etc. The performance requirement, computation requirement and performance metric for each RRM algorithm may be different.

Accordingly, the problem involves developing a solution that (i) allows different RRM/Optimization algorithms/services based on the performance and input data to detect a distribution shift for the model and update the model based on that, (ii) while minimizing data and processor overhead required for training the ML model to obtain good performance, (iii) in a manner that would be suitable to implement over a controller platform 221 such as a radio intelligent controller 208.

The problem involves the fact that the distribution of incoming data may change with time, hence, the existing model which is trained on past data may become obsolete. For example, FIG. 4A and FIG. 4B together show the changing distribution of cellular network load in the first half of a given week (FIG. 4A histogram) as compared to the cellular network load in the second half of the given week (FIG. 4B histogram). The associated performance challenge may be stated as, learning from new data in the absence of old data, or given a limited amount of old data, raises the stability-plasticity dilemma, where “stability” describes retaining existing knowledge and “plasticity” is learning new knowledge. On the other hand, while using past data, there can be memory constraints which force an inability to store too much of past raw data. Moreover, there can be compute constraints which force an inability to train the model using all of the past data in every update.

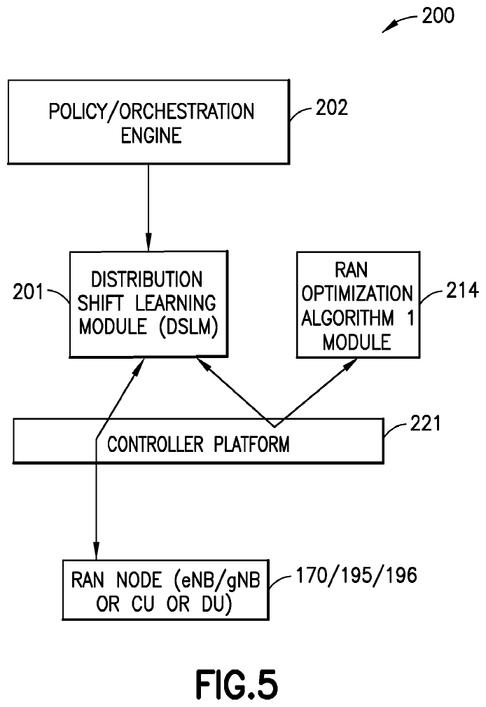

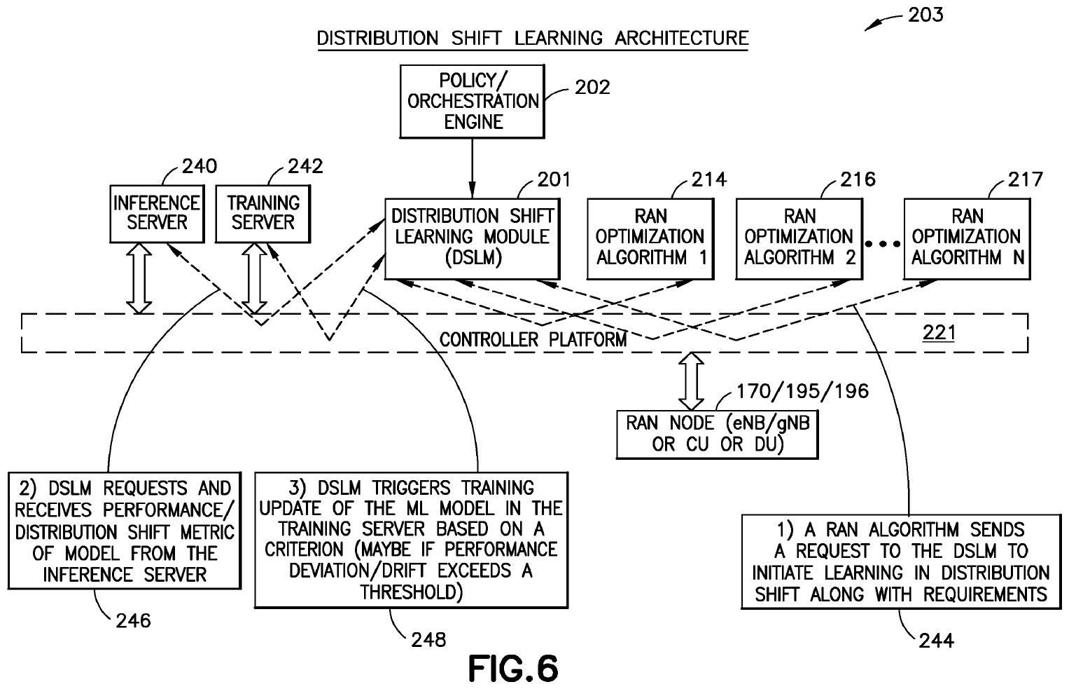

FIG. 5 is a block diagram 200 showing integration of distribution shift learning within a communication network. FIG. 6 shows an example distribution shift learning architecture 203.

Accordingly, with reference to FIG. 5 and FIG. 6, disclosed herein is a programmable distribution shift learning module (DSLM) 201 that supports an API to allow a RAN/RRM optimization/algorithm service (RAN optimization algorithm 1 214, RAN optimization algorithm 2 216, RAN optimization algorithm N 217) to discover the identity/address of the distribution shift learning module 201 and the service it provides. The DSLM 201 receives, via a policy API, an indication from the policy/orchestration engine 202, describing policies to be applied to distribution shift learning and requests from the RAN/RRM optimization algorithms module (214, 216, or 217), including: i) indications of which cells are to be handled by the distribution shift learning module 201, ii) indications of which algorithms are allowed to request distribution shift learning, iii) biasing/priority factors for certain cells/carriers, such as the amount of CPU and memory for cells, and iv) biasing/priority factors for certain RAN optimization algorithms, such as the amount of CPU and memory for the respective RAN optimization algorithm.

The DSLM 201 receives, via an API, a formula/function (amongst predefined choices) of one or more performance metric KPIs from a RAN/RRM optimization/algorithm service (214, 216, or 217) which is used by DSLM 201 to identify the distribution shift, along with additional attributes describing the characteristics of the distribution shift update/learning. Additional attributes may include: (i) a threshold of the evaluated formula/function performance metric over which shift is detected and the model updated (ii) a type of characteristic based on which distribution shift is detected, including at least one of average, maximum, a given percentile for confidence interval, trends, peak to average ratio, standard deviation and higher moments (iii) a list of underlying input KPIs of the ML model, including at least one of number of connected users, number of active users, number of bearers, DL or UL PRB utilization, PDCCH utilization, PUCCH utilization, composite available capacity, total data delivered or received at a RAN node etc., (iv) a complexity constraint measure denoting how often the ML model can be updated (v) a data storage constraint measure denoting how much data can be stored for updating the ML model (vi) a preference for passive (continuous learning without drift detection) or active learning (based on a characteristic of drift detected) model update. The interaction between the distribution shift learning module 201 and the RAN/RRM optimization algorithm service (214, 216, and/or 217) may be facilitated by the controller platform 221. The function/formula of the performance metric of the ML model can be for example, different error percentiles, mean error, absolute error etc., it may also include minimum performance expected from the model. The performance metric measures across different classes along with corresponding importance.

At 244 in FIG. 6, the RAN algorithm (214, 216, or 217) sends a request to the DSLM 201 to initiate learning in the distribution shift along with requirements. Based on the request 244 from the RAN/RRM optimization/algorithm service (214, 216, and/or 217), the DSLM 201 communicates with a RAN node 170 or the controller platform 221 to request data about one or more cells. Requested data, based on the request from the DSLM 201 to the RAN node 170/195/196, may include a number of connected users (or a counter of leaving/entering users), a number of active users, a number of bearers, DL or UL PRB utilization, PDCCH utilization, PUCCH utilization, composite available capacity etc.

The DSLM 201 communicates with the inference server 240 which contains the ML model and, also processes requested RAN data about the one or more cells to detect if there is a distribution shift. Refer to 246, where the DSLM 201 requests and receives at least one performance/distribution shift metric of the model from the inference server 240. If there is not sufficient shift, the DSLM module 210 communicates this to the RAN optimization algorithm (214, 216, and/or 217) with no model update, otherwise, communicates with the training server 242 to update the ML model. Refer to 248, where the DSLM 201 triggers a training update of the ML model in the training server 242 based on a criterion (e.g., if a performance/drift exceeds a threshold). The DSLM 201 provides the updated model/model ID to the inference server 240 via an API and reports to the optimization algorithm (214, 216, and/or 217) if the model update 248 was successful.

The inference server 240 may be instantiated in various ways. It could be instantiated as a standalone entity, or it could be instantiated as part of the RRM/RAN optimization module, or as a separate module on the RIC near-RT or RIC-non-RT platforms, or as part of a RAN node. Accordingly, the model is provided to the inference server 240, which, depending on the use case, may be instantiated at the RAN algorithm module/service (214, 216, or 217), or at the RAN node (170), or as a standalone entity (such as apparatus 1100), etc. The RAN algorithm module (214, 216, or 217) is the entity that is going to use the model at the inference server 240 to get an inference result that helps it make a determination/action for optimizing the RAN performance (e.g. of network 100).

The DSLM 201 includes or interfaces with one or more APIs. The policy engine 202 initiates the policy on the DSLM 201 using a ‘policy API’. The existing RAN optimization algorithm module (214, 216, and/or 217) handshakes with the DSLM block 210 using a ‘service discovery API’. The RAN specific optimization algorithm module (214, 216, or 217) sends the performance report to the DSLM 201 with additional attributes using a ‘distribution shift learning API’. Once the DSLM 201 decides that current performance is below the baseline and distribution shift needs to be detected, the DSLM 201 next initiates the data collection via messaging to the controller platform 221 (i.e. facilitates data collection), from cells of interest at the corresponding time granularity using a ‘data collection initiation API’ and then accesses collected data using a ‘data access API’ to further process and detect the distribution shift.

Note that previously collected data from cells may be also accessed from the controller platform 221 by the DSLM 201 using a ‘data access API’. The DSLM 201 communicates with the inference server 240 using a ‘distribution shift learning API’ and calculates the shift. Once the detected shift has been calculated, DSLM 201 communicates with the training server 242 using the ‘distribution shift learning API’ to update the corresponding ML model.

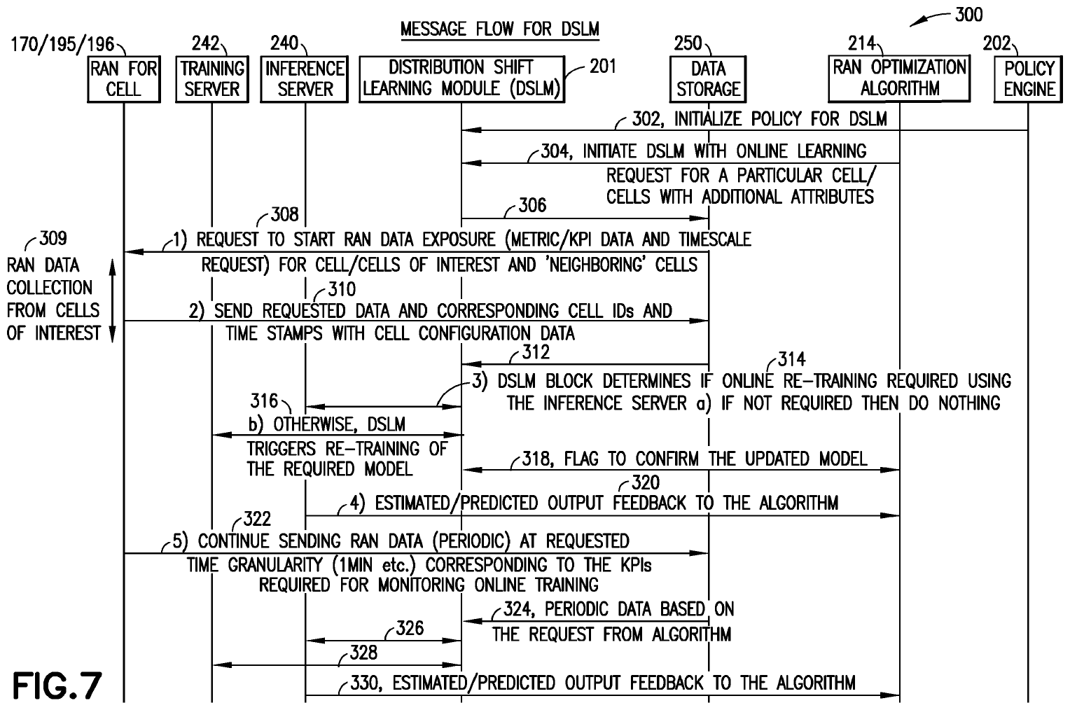

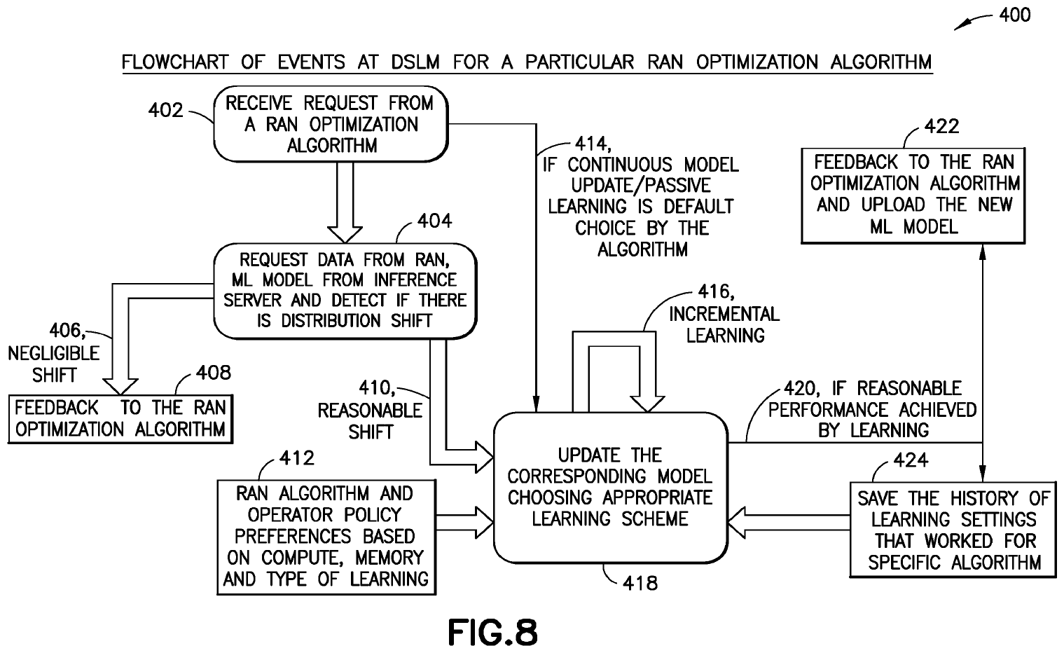

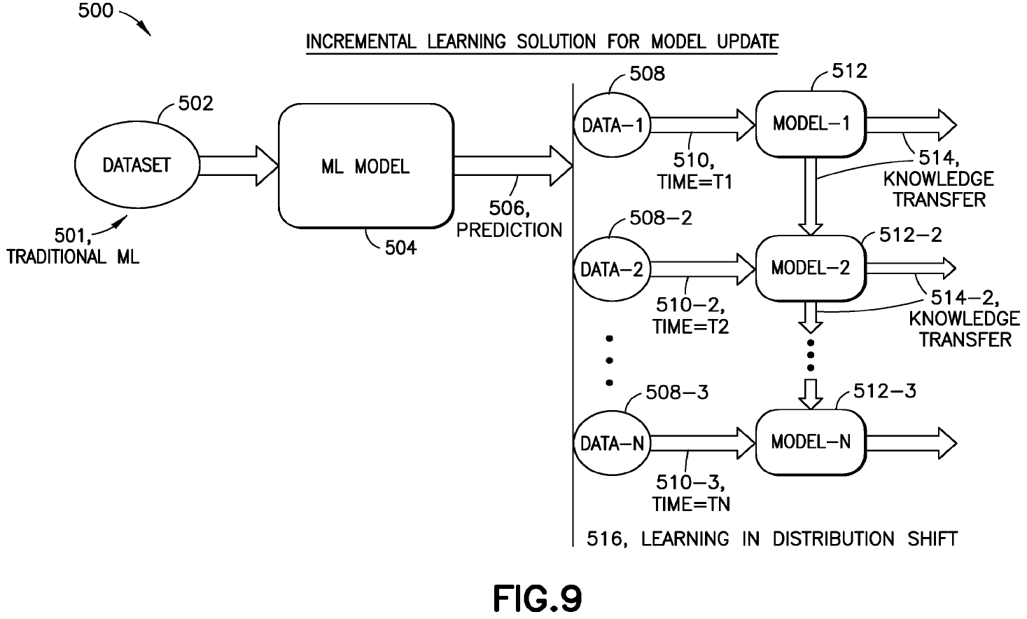

The distribution shift requirements (also based on performance of the ML model) of a RAN optimization algorithm (214, 216, or 217) may change with time and the algorithm (214, 216, or 217) can send a request with updated attributes to the DSLM 201. Also an operator can specify certain rules/constraints for shift learning. For example, during special events some cells may have high priority of distribution shift, etc. The messaging details 300 between the different modules on the platform and the DSLM 201 are shown FIG. 7, and the flowchart of events 400 at the DSLM 201 is shown in FIG. 8. Further details of the DSLM 201 for model update calculation are provided herein with reference to FIGS. 9-15 and as further described herein.

FIG. 7 illustrates the message flow 300 of the DSLM 201. At 302, the policy engine 202 initializes a policy for the DSLM 201. At 304, the RAN optimization algorithm 214 initiates the DSLM 201 with an online learning request for one or more cells with additional attributes. At 306, the DSLM may store information related to items 302 and 304 (e.g. the DSLM may cache the policy initialization or the online learning request). At 308, the data storage 250 provides to the RAN for the cell (170/195/196) a request to start RAN data exposure (such as metric/KPI data and a timescale request) for one or more cells of interest and neighboring cells. At 309, the RAN for the cell (170/195/196) performs RAN data collection from the one or more cells of interest. At 310, the RAN for the cell (170/195/196) provides the data storage 250 the requested data and corresponding cell IDs and one or more time stamps with cell configuration data. At 312, the data storage 250 provides the information obtained via item 310 to the DSLM 201.

At 314, via a communication exchange with the inference server 240, the DSLM 201 determines if online retraining is required using the inference server 240, and if not nothing is done. At 316, if the DSLM 201 determines at 314 that online retraining is required, the DSLM via a communication exchange with the training server 242 triggers retraining of the required model. At 318, the DSLM 201 via a communication exchange with the RAN optimization algorithm 214 provides a flag to confirm the updated model. At 320, the inference server 240 provides estimated/predicted output feedback to the RAN optimization algorithm 214.

At 322, the RAN for the cell (170/195/196) continues to send RAN data to the data storage 250 (e.g. periodically) at the requested time granularity (e.g. every 1 minute, etc.) corresponding to the KPIs required for monitoring online training. At 324, the data storage 250 provides the periodic data received at 322 to the DSLM 201 based on the request from the RAN optimization algorithm 214. At 326, the DSLM exchanges information (e.g. information obtained at 324) with the inference server 240. At 328, the DSLM 201 exchanges information (e.g. information obtained at 324) with the training server 242. At 330, the inference server 240 provides the estimated/predicted output feedback to the RAN optimization algorithm 214.

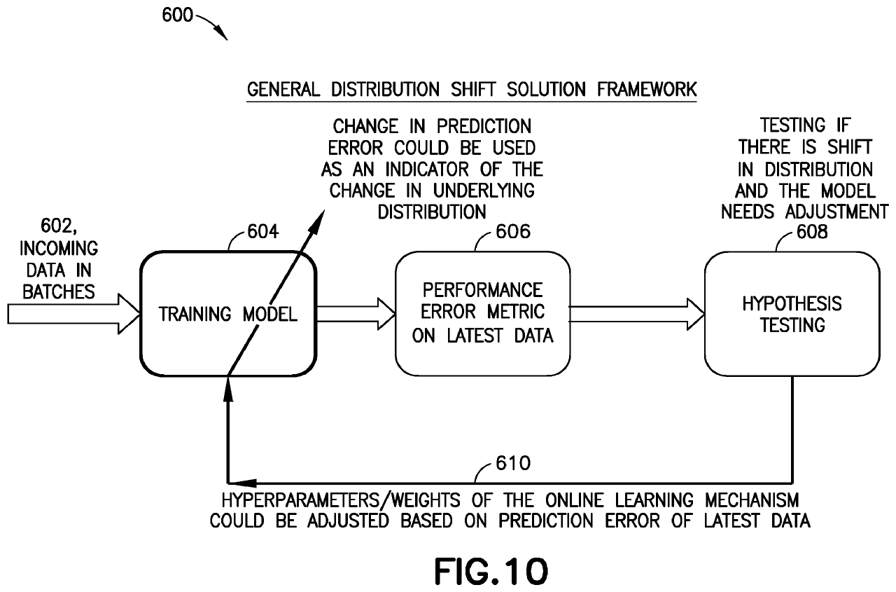

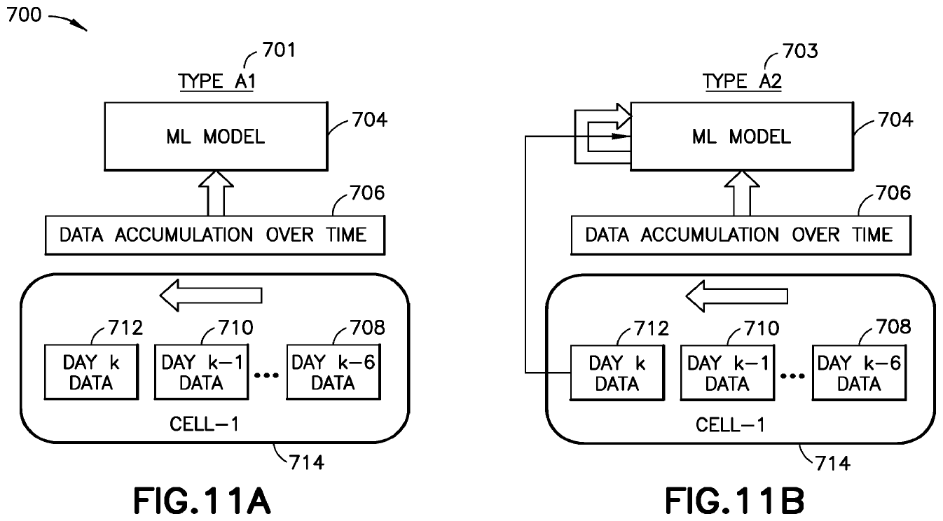

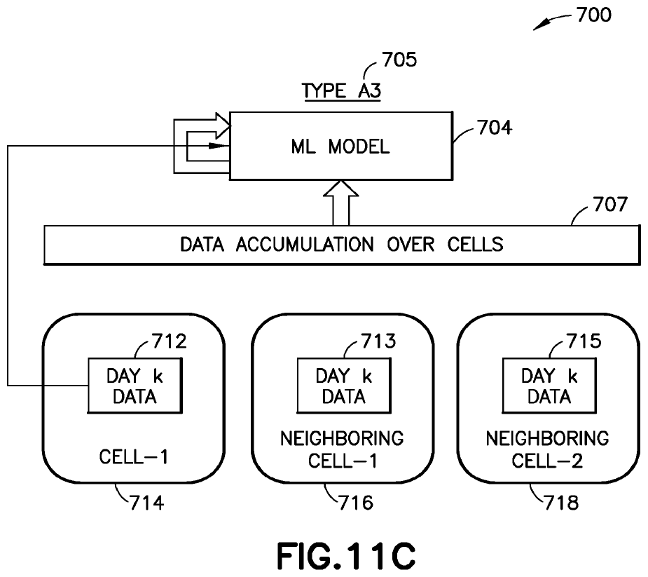

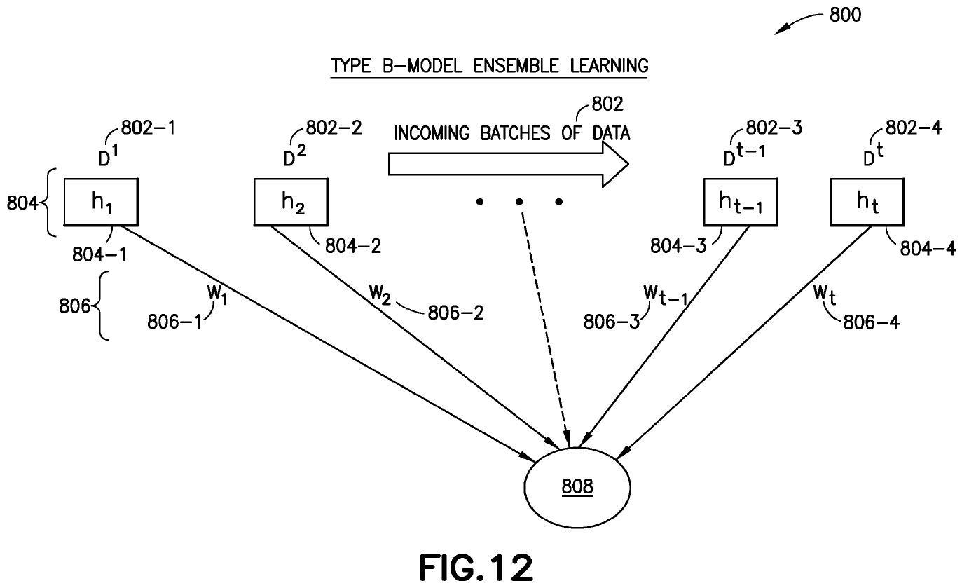

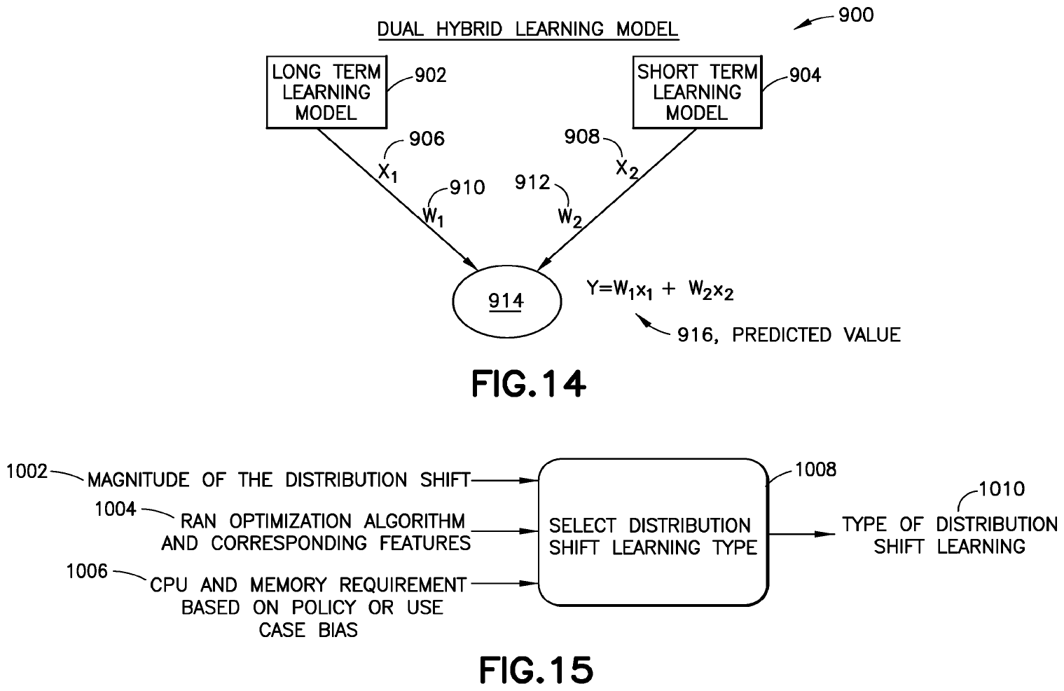

FIG. 8 shows a flowchart 400 of events at the DSLM 201 for a particular RAN optimization algorithm (e.g. any one of 214, 216, or 217). As can be seen, some of the items shown in FIG. 8 overlap with the items of the preceding figures, such as FIG. 6 and FIG. 7, however different reference numbers are provided for clarity and because the figures may represent embodiments that may differ even if there is some overlap. At 402, the DSLM 201 receives a request from a RAN optimization algorithm (214, 216, or 217). At 404, the DSLM 201 requests data from the RAN (such as the RAN, the RAN node 170, the DU 195, and/or the CU 196), and the DSLM 201 requests the ML model from the inference server 240 and detects if there is a distribution shift. In response to detection at 404 of a negligible shift (406), the DSLM 201 at 408 provides feedback to the RAN optimization algorithm (214, 216, or 217). In response to detection at 404 that there is a reasonable shift (410), the DSLM 201 at 418 updates the corresponding model choosing an appropriate learning scheme. For 418, the DSLM 201 at 412 is provided RAN algorithm and operator policy preferences based on computational and memory resources, and based on the type of learning. Also, at 414, for a continuous model update/passive learning is the default choice by the algorithm. With respect to 418, the DSLM 201 may perform incremental learning at 416. At 420, if the DSLM 201 determines that reasonable performance has been achieved by learning, then at 422 the DSLM 201 provides feedback to the RAN optimization algorithm (214, 216, or 217) and uploads the new ML model. At 424, the DSLM 201 saves the history of learning settings that worked for the specific algorithm (214, 216, or 217). Further detail on item 418 is provided in FIG. 9, FIG. 10, FIG. 11A, FIG. 11B, FIG. 11C, FIG. 12, and FIG. 14, in particular further details are provided on the types of shift learning and calculation details. The benefits of DSLM are also further described herein.

FIG. 9 and FIG. 10 describe the general idea of the model update in the DSLM 201.

FIG. 9 depicts an incremental learning solution 500 for the model update. The aim of incremental learning techniques is for the learning model to adapt to new data without forgetting its existing knowledge. The assumption is that new data distributions change with time. Two methods that may be used to achieve incremental learning are 1) re-training, and 2) fine tuning. The re-training method trains the ML model from scratch using new data (with the distribution shift) as well as past data. The fine tuning technique does not train the ML model from scratch, but instead fine tunes the existing model weights using the latest data. Re-training might be more useful when there is a large drift/shift. Fine tuning might be more useful when there is a small drift/shift of the distribution.

In FIG. 9, traditional ML 501 is shown on the left, where a dataset 502 is provided to an ML model 504, which ML model 504 provides a prediction 506. The incremental solution 500 is shown on the right of FIG. 9 (learning in distribution shift 516), where at time=T1 510 data-1 508 is provided to model-1 512, which model-1 512 provides knowledge transfer 514 to the next incremental learning iteration using data-2 508-2 at time=T2 510-2. At time=T2 510-2 data-2 508-2 is provided to model-2 512-2, which model-2 512-2 provides knowledge transfer 514-2 to a next incremental learning iteration. In FIG. 9, this procedure continues for N iterations, the Nth iteration being that at time=TN 510-3. At time=TN 510-3, data-N 508-3 is provided to model-N 512-3 to perform a prediction. Accordingly, model-1 512, model-2 512-2, and model-N 512-3 may represent different versions of a model that is fine tuned or retrained at each incremental iteration.

FIG. 10 depicts a general distribution shift solution framework 600. At 602, data is incoming in batches, as input to the training model 604. Item 606 is developing a performance error metric on the latest data. The change in prediction error may be used as an indicator of the change in the underlying distribution. Item 608 is hypothesis testing, or testing if there is a shift in the distribution and the model needs adjustment. Hypothesis testing 608 provides feedback 610 to the training model 604. At 610, hyperparameters/weights of the online learning mechanism may be adjusted based on the prediction error of the latest data.

FIGS. 11A, 11B, 11C, 12, 13, and 14 describe different types of learning. FIG. 15 describes choosing the right type of learning.

FIG. 11A, FIG. 11B, and FIG. 11C describe Type A batch learning using a single model 700. FIG. 11A, FIG. 11B, and FIG. 11C are variations of each other, where FIG. 11A depicts Type A1 learning 701, FIG. 11A depicts Type A2 learning 703, and FIG. 11C depicts Type A3 learning 705. For Type A1 learning 701, the model 704 is re-trained every day from scratch using batch data comprising the last N=7 days. The batch data within cell-1 714 includes day k-6 data 708 (e.g. Monday), day k-1 data 710 (e.g. Saturday), up to day k data 710 (e.g. Sunday). The batch data is data accumulation over time 706.

For Type A2 learning 703 as shown in FIG. 11B, the model 704 is fine tune trained using a batch of the last day data (day k data 712), starting from the previous weights. Also, for Type A2 learning 703, let M be the number of days under consideration (e.g. M=7). If (k % M==0), then retrain the model from scratch using a batch of the last N=7 days of data, where the batch of the last N=7 days of data is data accumulation over time 706 comprising day k data 712, day k-1 data 710, and day k-6 data 708).

For Type A3 learning 705 as shown in FIG. 11C, the ML model 704 for cell-1 714 is fine tune trained every day, starting from the previous model weights, using a batch of the last day data (i.e. day k data 712) from cell-1 714. Also, for Type A3 learning 705, let M again be the number of days under consideration (e.g. M=7). If (k % M==0), then retrain a model 704 from scratch using aggregated batches of last day data from all cells, namely using data accumulation over cells 707 (or at least a group of cells comprising the current cell and at least one other neighboring cell), where e.g. the last day data for cell-1 714 is day k data 712, the last day data for neighboring cell-1 716 is day k data 713, and the last day data for neighboring cell-2 718 is day k data 715. Data accumulation 707 can be inside the eNB/gNB 170 if only data from that eNB/gNB 170 is used, otherwise the data accumulation is outside the eNB/gNB 170 in an accumulation server or a NetAct server. Values N (days used for the batch) and M (total days) are considered to be fixed in some examples, but N and M can be tuned based on the data characteristics.

FIG. 12 describes Type B—Model Ensemble Learning 800. For Type B learning 800, the last t models are saved instead of saving batches of data. The models may be quantized to the last K best performing models, or simply the last K models. The output of the model ensemble is combined to obtain a final output. As shown in FIG. 12, incoming batches of data 802 (including D¹ 802-1, D² 802-2, D³ 802-3, and D⁴ 802-4) are processed by node 808. The weights 806 (including W₁ 806, W₂ 806-2, Wₜ₋₁ 806-3, and Wₜ 806-4) are based on the accuracy of the model on the latest data. Hypotheses/classifiers 804 of the model include h₁ 804-1, h₂ 804-2, hₜ₋₁ 804-3, and hₜ 804-4.

hₜ denotes the latest model trained on the batch of data D^{t}. The latest model hₜ can be trained based on fine tuning training or incremental training. Note that the index 1, 2, 3 . . . t denotes the index of saved models, where t is the index of latest model saved. The number of saved models can be limited to K which is determined by a memory constraint. K models could be chosen based on criteria for example, best performing, best recent performance, latest models etc.

The output of node 808 is given by:

H^{t}(x′(i))=arg max_{c}ΣₖWₖ^{t}·[[hₖ(x^{t}(i))=c]] (Equation 1).

In Equation 1, H is the hypothesis space of hypotheses/classifiers, c is a particular class in the set of classes in the classification problem, k is saved model classifiers index, x is a feature vector having discrete or real values, t is the current/latest time index, and i is the index of feature vector or input x, where the arg max function returns the class c argument or the final hypothesis function H^{l}(x^{l}(i)) that is a weighted sum of saved models, and Σ is the sum function.

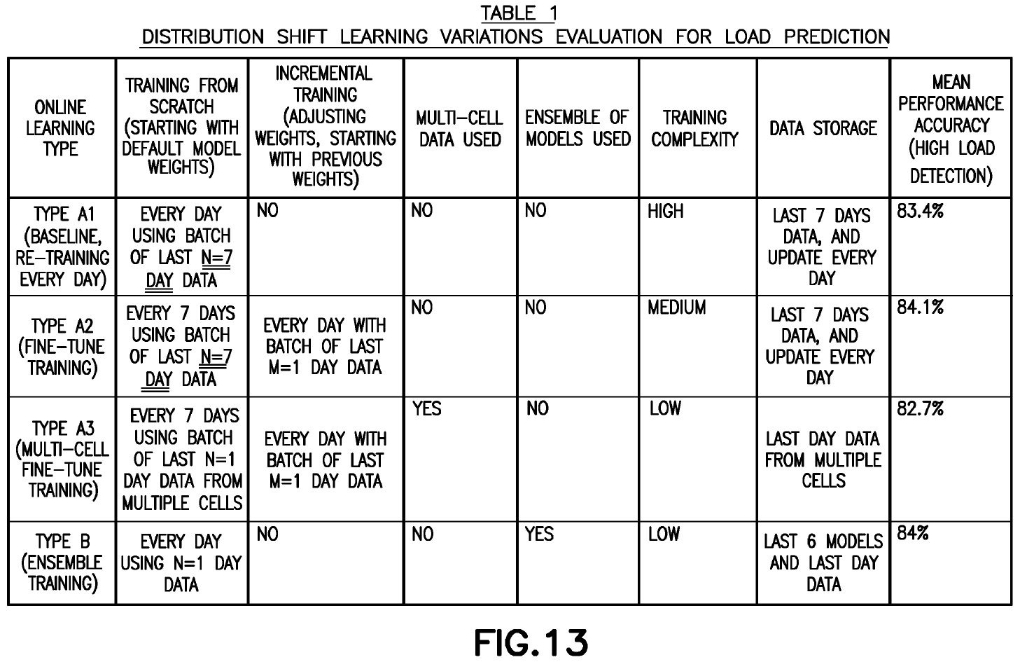

The performance of different types of model update learning in the load prediction use case scenario for RAN, was evaluated, which evaluation is shown in FIG. 13 (Table 1). The aim is to predict the future load given the past load and other related features. Thus, the RAN algorithm here is the load prediction module. The model corresponds to NN based load prediction. The model update refers to the update of weights of the NN used to predict future load. Table 1 of FIG. 13 therefore provides a distribution shift learning variations evaluation for load prediction. As shown in FIG. 13, the mean performance accuracy of Type A1 learning 701 (baseline, re-training every day), Type A2 learning 703 (fine-tune training), Type A3 learning 705 (multi-cell fine-tune training), and Type B learning 800 (ensemble training) is 83.4%, 84.1%, 82.7%, and 84%, respectively. Note that the different types of learning provide at par performance with each other. The advantage of Type B learning is that there is no need to save the data batches and save memory, and rather the ensemble of models can be saved. The advantage of the A2, A3 and B types of learning over the A1 type of learning is the limited compute required for training. Thus, the appropriate type of learning can be chosen based on memory and compute constraints.

More than one way of learning can be combined, as shown in FIG. 14. FIG. 14 depicts an example dual hybrid learning model 900. The dual hybrid learning model 900 includes a long term learning model 902 that is trained on long term data, and short term learning model 904 that is trained on the latest short term data. The long term learning model 902 includes parameter x₁ 906 (e.g. a first model feature vector) and is weighted by weight W₁ 910. The short term learning model 904 includes parameter x₂ 908 (e.g. a second model feature vector) and is weighted by weight W₂ 912. Parameters x₁ 906 and x₂ 908, and weights W₁ 910 and W₂ 912 are input to node 914 that determines a predicted value Y 916, which for example is determined as a weighted combination of the long term learning model and the short term learning model as Y=W₁x₁+W₂x₂. In one embodiment of the dual hybrid learning model 900, W₁=0 and W₂=1 if the performance in terms of the prediction error of the long term online model 902 is inferior to the short term model 904, and W₁=1 and W₂=0 otherwise. In another embodiment of the dual hybrid learning model 900, W₁=0 and W₂=1 if the KL distance of the current week load distribution with respect to the previous week distribution is more than a threshold, and W₁=1 and W₂=0 otherwise.

FIG. 15 shows selecting 1008 a distribution shift learning type 1010 in the DSLM 201 load prediction for an example use case. Here the RAN optimization algorithm is the load prediction module. Thus the model refers to a NN based prediction model. There is a need to decide whether to use a full retraining for the load prediction use case, or whether to use ensemble learning or use a reduced-complexity tuning. The learning type can be chosen from a set of predefined learning choices for example, A1-A3 type or Type B. The decision can be based on the inputs in FIG. 15, including the magnitude of the distribution shift 1002, the RAN optimization algorithm (214, 216, or 217) and corresponding features 1004, and a CPU and memory requirement based on policy or use case bias 1006. In addition to these factors, the right update method 1010 may be chosen 1008 in following way: 1) at first starting from scratch, use a full brute force training for the first few days while accumulating an ensemble of models and past data; 2) then once the ensemble of models has been assembled, it would start to also check whether the ensemble based update would work well or even fine tuning the model update works well and then limited data can be stored. The choice amongst different learning can be done similar to the dual hybrid learning model 900, where the learning type which performs best on latest data is used; and 3) eventually settle into some rhythm where e.g. once every N days it may do a full retraining from scratch but in between tends to do ensemble-based updates etc.

Further details of the DSLM 201 include the following. Each RAN optimization algorithm (214, 216, or 217) may use a different ML/deep learning model. Example ML/deep learning models that may be used include MLP NN, LSTM, reinforcement learning, random forest, GAN etc. Various distribution shift detection like density estimation (KL distance), error shift etc. can be used by the DSLM 201 to detect drift. In principle there might be different instances of DSLM 201 running for different RAN optimization algorithm (e.g. 214, 216, or 217). An extension to distribution shift learning across different RAN algorithms may be used, where such a DSLM could also provide common distribution shift detection across different RAN algorithms based on inputs (with shift) to ML models, and not just a single RAN algorithm.

There are several benefits and technical effects of the described examples. The described solution allows different RRM optimization algorithms and services to be able to update and tune in a flexible, programmable way. Further, the described examples minimize data requirements as data from the RAN node needs only to be sent to the data sink for DSLM, and does not have to be individually sent to each RRM/optimization algorithm that needs to calculate the cell grouping. The solution also enables practical deployment of any ML based solution in the field APIs. The design is suitable to implement over a controller platform such as a radio intelligent controller. In addition, service-discovery APIs allow any RRM/Optimization algorithm/service to discover the DSLM, and flexible APIs can be mapped to the API-X (RIC) or C1 interface xRAN terminology).

There is good potential for standardization in the xRAN Forum/oRAN alliance. For example, xRAN/oRAN is interested in standardizing open interfaces towards RAN, and developing an open platform for radio intelligent controllers. The APIs of the described load module can map to the ‘C1’ interface in xRAN. There is also good potential for an owned but open/published API as well. For example, the radio intelligent controller may include an “API X” which allows different modules/optimization services to be instantiated on a common RIC platform, and which would support third party optimization algorithms (such as operator-developed algorithms) with open APIs. APIs could be either internally developed and published, or standardized in xRAN/oRAN. The described distribution shift learning module could be one such application for which APIs can be published and all or portions of that can be standardized in xRAN/oRAN. A network interface (such as link 131 of FIG. 1) may be used for the DSLM and also for updating the ML models.

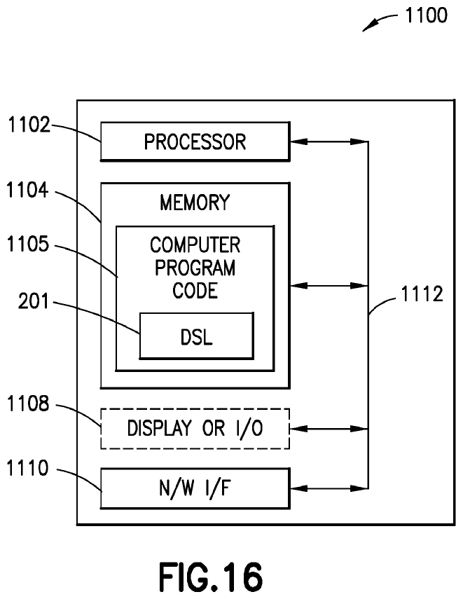

FIG. 16 is an apparatus 1100 which may be implemented in hardware, configured to implement adaptive learning in distribution shift for RAN AI/ML models, based on any of the examples described herein. The apparatus comprises a processor 1102, at least one non-transitory memory 1104 including computer program code 1105, wherein the at least one memory 1104 and the computer program code 1105 are configured to, with the at least one processor 1102, cause the apparatus to implement circuitry, a process, component, module, and/or function (collectively 201) to implement distribution shift learning (DSL), based on the examples described herein. The apparatus 1100 optionally includes a display and/or I/O interface 1108 that may be used to display an output of a result of the DSL 201. The display and/or I/O interface 1108 may also be configured to receive input such as user input (e.g. with a keypad). The apparatus 1100 also includes one or more network (NW) interfaces (I/F(s)) 1110. The NW I/F(s) 1110 may be wired and/or wireless and communicate over a channel or the Internet/other network(s) via any communication technique. The NW I/F(s) 1110 may comprise one or more transmitters and one or more receivers. The N/W I/F(s) 1110 may comprise standard well-known components such as an amplifier, filter, frequency-converter, (de)modulator, and encoder/decoder circuitry(ies) and one or more antennas. In some examples, the processor 1102 is configured to implement item 201 without use of memory 1104.

The apparatus 1100 may be a remote, virtual or cloud apparatus. The apparatus 1100 may be part of functionality of the network element(s) 190. Alternatively the apparatus 1100 may be part of functionality of the RAN node 170 or the user equipment (UE) 110.

The memory 1104 may be implemented using any suitable data storage technology, such as semiconductor based memory devices, flash memory, magnetic memory devices and systems, optical memory devices and systems, fixed memory and removable memory. The memory 1104 may comprise a database for storing data. Interface 1112 enables data communication between the various items of apparatus 1100, as shown in FIG. 16. Interface 1112 may be one or more buses, or interface 1112 may be one or more software interfaces configured to pass data between the items of apparatus 1100. For example, the interface 1112 may be one or more buses such as address, data, or control buses, and may include any interconnection mechanism, such as a series of lines on a motherboard or integrated circuit, fiber optics or other optical communication equipment, and the like. The apparatus 1100 need not comprise each of the features mentioned, or may comprise other features as well. The apparatus 1100 may be an embodiment of the apparatuses shown in FIG. 1A, FIG. 1B, FIG. 1C-1, FIG. 1C-2, FIG. 1D, FIG. 2 and/or FIG. 3.

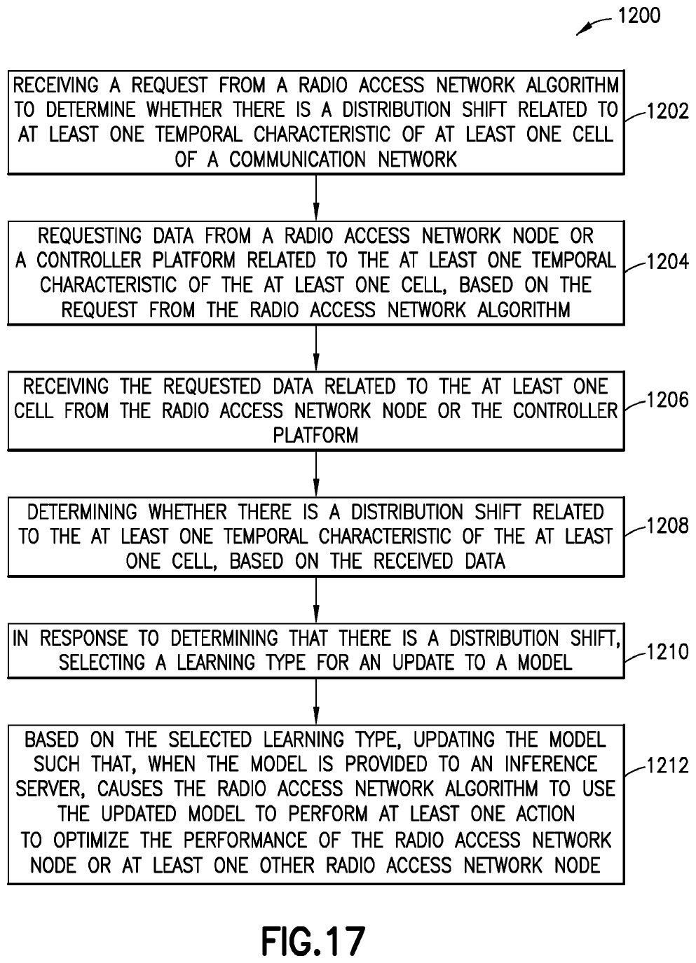

FIG. 17 is a method 1200 to implement adaptive learning in distribution shift for RAN AI/ML models, based on the examples described herein. At 1202, the method includes receiving a request from a radio access network algorithm to determine whether there is a distribution shift related to at least one temporal characteristic of at least one cell of a communication network. At 1204, the method includes requesting data from a radio access network node or a controller platform related to the at least one temporal characteristic of the at least one cell, based on the request from the radio access network algorithm. At 1206, the method includes receiving the requested data related to the at least one cell from the radio access network node or the controller platform. At 1208, the method includes determining whether there is a distribution shift related to the at least one temporal characteristic of the at least one cell, based on the received data. At 1210, the method includes in response to determining that there is a distribution shift, selecting a learning type for an update to a model. At 1212, the method includes based on the selected learning type, updating the model such that, when the model is provided to an inference server, causes the radio access network algorithm to use the updated model to perform at least one action to optimize the performance of the radio access network node or at least one other radio access network node. Method 1200 may be implemented with apparatus 1100 or with one or more of the apparatuses depicted in FIG. 2 and/or FIG. 3, or with one or more of the items shown in FIG. 1A, FIG. 1B, FIG. 1C-1, FIG. 1C-2, FIG. 1D including network element(s) 190, RAN node 170, or UE 110. In addition, method 1200 may be implemented with the DSLM/DSL 201 (including DSL 201 of apparatus 1100), the RAN optimization algorithm (214, 216, or 217), the SMO 202, the RIC 208, the non-RT RIC 220, the near-RT RIC 210, or any combination of these.

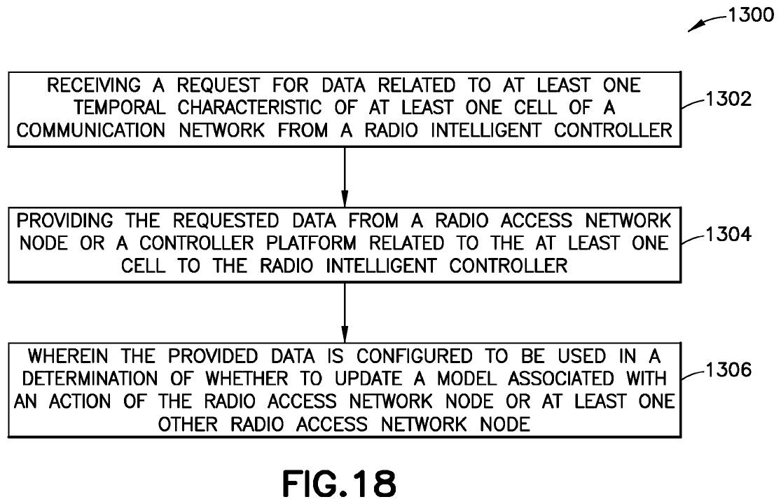

FIG. 18 is another method 1300 to implement adaptive learning in distribution shift for RAN AI/ML models, based on the examples described herein. At 1302, the method includes receiving a request for data related to at least one temporal characteristic of at least one cell of a communication network from a radio intelligent controller. At 1304, the method includes providing the requested data from a radio access network node or a controller platform related to the at least one cell to the radio intelligent controller. At 1306, the method includes wherein the provided data is configured to be used in a determination of whether to update a model associated with an action of the radio access network node or at least one other radio access network node. Method 1300 may be implemented with apparatus 1100, RAN node 170, controller platform 221, or any combination of these.

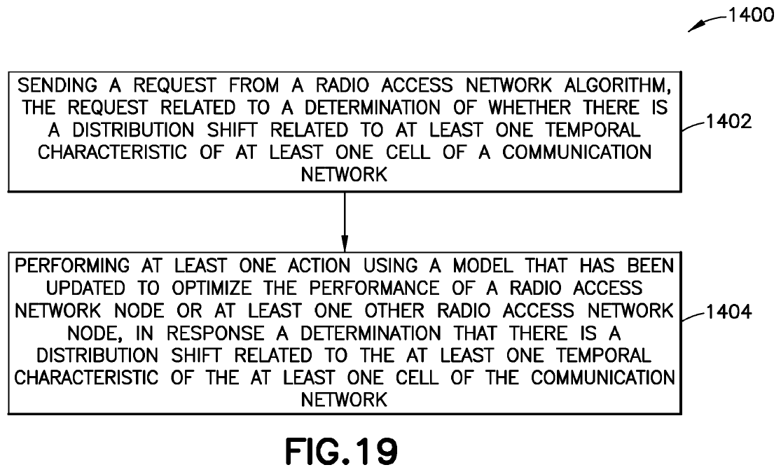

FIG. 19 is another method 1400 to implement adaptive learning in distribution shift for RAN AI/ML models, based on the examples described herein. At 1402, the method includes sending a request from a radio access network algorithm, the request related to a determination of whether there is a distribution shift related to at least one temporal characteristic of at least one cell of a communication network. At 1404, the method includes performing at least one action using a model that has been updated to optimize the performance of a radio access network node or at least one other radio access network node, in response a determination that there is a distribution shift related to the at least one temporal characteristic of the at least one cell of the communication network. Method 1400 may be implemented with apparatus 1100, the RAN optimization algorithm (214, 216, and/or 217), and a combination of these.

References to a ‘computer’, ‘processor’, etc. should be understood to encompass not only computers having different architectures such as single/multi-processor architectures and sequential/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry may also be used to mean a function or a process, such as one implemented by distributed shift learning.

An example apparatus includes at least one processor; and at least one non-transitory memory including computer program code; wherein the at least one memory and the computer program code are configured to, with the at least one processor, cause the apparatus at least to: receive a request from a radio access network algorithm to determine whether there is a distribution shift related to at least one temporal characteristic of at least one cell of a communication network; request data from a radio access network node or a controller platform related to the at least one temporal characteristic of the at least one cell, based on the request from the radio access network algorithm; receive the requested data related to the at least one cell from the radio access network node or the controller platform; determine whether there is a distribution shift related to the at least one temporal characteristic of the at least one cell, based on the received data; in response to determining that there is a distribution shift, select a learning type for an update to a model; and based on the selected learning type, update the model such that, when the model is provided to an inference server, causes the radio access network algorithm to use the updated model to perform at least one action to optimize the performance of the radio access network node or at least one other radio access network node.

Other aspects of the apparatus may include the following. The at least one memory and the computer program code may be further configured to, with the at least one processor, cause the apparatus at least to: monitor multiple distribution shifts of the at least one cell in parallel; wherein at least one of: different radio access network algorithms are used for the at least one cell; the radio access network algorithm or different algorithms are used for different cells; the radio access network algorithm or different algorithms are used for a virtual grouping of the at least one cell; or the radio access network algorithm or different algorithms are used for an aggregation of two or more cells comprising the at least one cell. The at least one memory and the computer program code may be further configured to, with the at least one processor, cause the apparatus at least to: receive, via an application programming interface, a formula/function of a key performance indicator among predefined choices from the radio access network algorithm, a radio access network service, or radio resource management algorithm/service which is used with a distribution shift learning module to determine the distribution shift; and receive, via the application programming interface, at least one additional attribute describing characteristics of the distribution shift determination or model update. The at least one additional attribute may comprise at least one of: a threshold of an evaluation of the formula/function of the key performance indicator over which the distribution shift is determined and model updated; a type of characteristic based on which the distribution shift is determined, the type of characteristic comprising at least one of an average, a maximum, a given percentile for a confidence interval, a trend, a peak to average ratio, or a standard deviation and higher moment; a list of underlying input key performance indicators of the model, the underlying input key performance indicators comprising at least one of a number of connected users, a number of active users, a number of bearers, downlink or uplink physical resource block utilization, physical downlink control channel utilization, physical uplink control channel utilization, composite available capacity, or total data delivered or received at the radio access network node; a complexity constraint measure denoting how often the model can be updated; a data storage constraint measure denoting how much data can be stored for updating the model; or a preference for a passive learning model update or an active learning model update, wherein the passive learning model update comprises continuous learning without drift detection, and wherein the active learning model update is based on a characteristic of the determined distribution shift. An interaction between the distribution shift learning module and the radio access network algorithm, the radio access network service, or the radio resource management algorithm/service may be facilitated with the controller platform. The request from the radio access network algorithm may comprise a function/formula performance metric of the model, the function/formula performance metric of the model being at least one of different error percentiles, mean error, or absolute error; wherein the function/formula performance metric measures across different classes along with corresponding importance; and the request from the radio access network algorithm includes a minimum performance expected from the model. The at least one memory and the computer program code may be further configured to, with the at least one processor, cause the apparatus at least to: receive an identifier of the at least one cell, at least one time stamp, and configuration data together with the requested data from the radio access network node or the controller platform. The model may be a machine learning model, and the model may comprise at least one of: a deep neural network, a random forest, a support vector machine, a Bayesian network, nearest neighbor, reinforcement learning, or a statistical model. The at least one memory and the computer program code may be further configured to, with the at least one processor, cause the apparatus at least to: inform the radio access network algorithm that there is an update to the model, in response to determining that there is a distribution shift and updating the model; and inform the radio access network algorithm that there is no update to the model, in response to determining that there is no distribution shift and not updating the model. The at least one memory and the computer program code may be further configured to, with the at least one processor, cause the apparatus at least to: receive the model from the inference server prior to updating the model; and provide an identifier of the model to the inference server following the update of the model. The apparatus may be or may be part of either a non-real-time radio intelligent controller, a near-real-time radio intelligent controller, or an intelligent controller. The at least one memory and the computer program code may be further configured to, with the at least one processor, cause the apparatus at least to: receive, from a policy orchestration engine, an indication of a policy to apply to learning the distribution shift; wherein the model is updated based on the policy. The policy may comprise at least one of: an indication of which of the at least one cell is to be handled using a distribution shift learning module; an indication of which algorithms, including the radio access network algorithm, are allowed to request distribution shift learning; at least one biasing/priority factor for the at least one cell or carrier, the at least one biasing/priority factor for the at least one cell or carrier comprising a central processing unit metric or a memory for the at least one cell or carrier; or at least one biasing/priority factor for the radio access network algorithm, the at least one biasing/priority factor for the radio access network algorithm comprising a central processing unit metric or a memory for the radio access network algorithm. The at least one memory and the computer program code may be further configured to, with the at least one processor, cause the apparatus at least to: continue to receive the requested data from the radio access network node or the controller platform within at least one suitable interval; determine at or within the at least one suitable interval whether there has been a further distribution shift; and update the model at or within the at least one suitable interval in response to a determination that there has been a further distribution shift. The at least one memory and the computer program code may be further configured to, with the at least one processor, cause the apparatus at least to: receive feedback from the radio access network algorithm related to the performance of the updated model; and store at least one characteristic related to the updated model in response to the feedback indicating that the radio access network algorithm achieved reasonable performance using the updated model. The at least one characteristic related to the updated model that is stored may comprise at least one of a data window size related to the model, a size of an ensemble of models, or the type of learning selected for the model. The model may be updated using a training server. The distribution shift may be determined in response to the at least one temporal performance characteristic of the at least one cell exceeding a threshold. The distribution shift may be determined based on a temporal change in a joint distribution of an input and an output of the model. The distribution shift may be determined using at least one of density estimation, a distribution distance metric, or error shift estimation. The distribution distance metric may be a Kullback Leibler distance. The learning type may be at least one or a combination of the following: re-training the model using the received data related to the at least one cell and past data related to the at least one cell; fine tuning the model using the received data related to the at least one cell; or accumulating an ensemble of a plurality of models including a latest model trained on recent data, where the ensemble of models is related to at least one aspect of the radio access network algorithm, wherein the model is an updated combination of the ensemble of the plurality of models, wherein the number of the plurality of models of the ensemble is configurable. The learning type may be selected based on at least one characteristic of the distribution shift, at least one feature of the radio access network algorithm, and at least one processor/memory requirement. The fine tuning of the model may update the model using data from at least one past interval, the at least one past interval comprising at least one day. The re-training of the model may update the model from scratch using data from at least one past interval, the at least one past interval comprising at least one day. The latest model added to the ensemble of models may be obtained by re-training or fine-tuning of an existing model from at least one past interval, the at least one past interval comprising at least one day. The fine tuning of the model or re-training of the model or the ensemble of models may update the model using data from at least one neighboring cell in addition to data from the at least one cell. A weight attributed to a model of the ensemble of the plurality of models may be proportional to a performance of the plurality of models on a latest dataset. The at least one memory and the computer program code may be further configured to, with the at least one processor, cause the apparatus at least to: accumulate the received data from the radio access network node or the controller platform related to the at least one temporal characteristic of the at least one cell based on at least one memory requirement; and re-train or fine tune the model using the accumulated data; wherein a duration over which the data is accumulated is tunable. The accumulating of the ensemble of the plurality of models may be based on at least one memory requirement. The model may be updated using a weighted combination of a long term learning model trained on long term data and a short term learning model trained on short term data, wherein a first weight is attributed to the long term learning model and a second weight is attributed to the short term learning model. The at least one memory and the computer program code may be further configured to, with the at least one processor, cause the apparatus at least to: assign to the first weight a first weight value and assign to the second weight a second weight value, the second weight value being higher than the first weight value, in response to a prediction error of the long term model being worse than the short term model, otherwise assign to the first weight the second weight value and assign to the second weight the first weight value; or assign to the first weight the first weight value and assign to the second weight the second weight value, in response to a probability distribution distance of a current week load distribution with respect a previous week load distribution being greater than a threshold, otherwise assign to the first weight the second weight value and assign to the second weight the first weight value. Long term and short term learning may be any learning type selected from among re-training, fine-tuning, or accumulating an ensemble of models. The inference server may be instantiated as either: a standalone entity; part of the radio access network algorithm; part of a radio intelligent controller near real-time platform; part of a radio intelligent controller non real-time platform; or part of the radio access network node. The at least one action may comprise at least one of: an update to a channel quality indicator reporting interval for at least one user of the radio access network node or the at least one other radio access network node; a modification to at least one measurement offset for the at least one user of the radio access network node or the at least one other radio access network node that changes at least one signal level at which a handover is triggered; a change to an admission control threshold for the at least one user of the radio access network node or the at least one other radio access network node; or a change to a carrier aggregation threshold for the at least one user of the radio access network node or the at least one other radio access network node.

An example apparatus includes at least one processor; and at least one non-transitory memory including computer program code; wherein the at least one memory and the computer program code are configured to, with the at least one processor, cause the apparatus at least to: receive a request for data related to at least one temporal characteristic of at least one cell of a communication network from a radio intelligent controller; and provide the requested data from a radio access network node or a controller platform related to the at least one cell to the radio intelligent controller; wherein the provided data is configured to be used in a determination of whether to update a model associated with an action of the radio access network node or at least one other radio access network node.

Other aspects of the apparatus may include the following. The at least one memory and the computer program code may be further configured to, with the at least one processor, cause the apparatus at least to: provide an identifier of the at least one cell, at least one time stamp, and configuration data together with the requested data from the radio access network node or the controller platform. The at least one memory and the computer program code may be further configured to, with the at least one processor, cause the apparatus at least to: continue to provide the requested data from the radio access network node or the controller platform within at least one suitable interval to the radio intelligent controller. The model may be a machine learning or artificial intelligence model. The apparatus may be or may be part of either a radio access network node or a controller platform.

An example apparatus includes at least one processor; and at least one non-transitory memory including computer program code; wherein the at least one memory and the computer program code are configured to, with the at least one processor, cause the apparatus at least to: send a request from a radio access network algorithm, the request related to a determination of whether there is a distribution shift related to at least one temporal characteristic of at least one cell of a communication network; and perform at least one action using a model that has been updated to optimize the performance of a radio access network node or at least one other radio access network node, in response a determination that there is a distribution shift related to the at least one temporal characteristic of the at least one cell of the communication network.

Other aspects of the apparatus may include the following. The at least one action may comprise at least one of: an update to a channel quality indicator reporting interval for at least one user of the radio access network node or the at least one other radio access network node; a modification to at least one measurement offset for the at least one user of the radio access network node or the at least one other radio access network node that changes at least one signal level at which a handover is triggered; a change to an admission control threshold for the at least one user of the radio access network node or the at least one other radio access network node; or a change to a carrier aggregation threshold for the at least one user of the radio access network node or the at least one other radio access network node. The at least one memory and the computer program code may be further configured to, with the at least one processor, cause the apparatus at least to: provide, via an application programming interface, a formula/function of a key performance indicator among predefined choices from the radio access network algorithm; and provide, via the application programming interface, at least one additional attribute describing characteristics of the distribution shift determination or model update. The at least one additional attribute may comprise at least one of: a threshold of an evaluation of the formula/function of the key performance indicator over which the distribution shift is determined and model updated; a type of characteristic based on which the distribution shift is determined, the type of characteristic comprising at least one of an average, a maximum, a given percentile for a confidence interval, a trend, a peak to average ratio, or a standard deviation and higher moment; a list of underlying input key performance indicators of the model, the underlying input key performance indicators comprising at least one of a number of connected users, a number of active users, a number of bearers, downlink or uplink physical resource block utilization, physical downlink control channel utilization, physical uplink control channel utilization, composite available capacity, or total data delivered or received at the radio access network node; a complexity constraint measure denoting how often the model can be updated; a data storage constraint measure denoting how much data can be stored for updating the model; or a preference for a passive learning model update or an active learning model update, wherein the passive learning model update comprises continuous learning without drift detection, and wherein the active learning model update is based on a characteristic of the determined distribution shift. An interaction between a distribution shift learning module and the radio access network algorithm may be facilitated with a controller platform. The request from the radio access network algorithm may comprise a function/formula performance metric of the model, the function/formula performance metric of the model being at least one of different error percentiles, mean error, or absolute error; wherein the function/formula performance metric measures across different classes along with corresponding importance; and the request from the radio access network algorithm includes a minimum performance expected from the model. The at least one memory and the computer program code may be further configured to, with the at least one processor, cause the apparatus at least to: receive an indication that there is an update to the model, in response to there being a distribution shift and model update. The at least one memory and the computer program code may be further configured to, with the at least one processor, cause the apparatus at least to: provide feedback from the radio access network algorithm related to the performance of the updated model to an intelligent controller. The model may be a machine learning or artificial intelligence model. The apparatus may implement the radio access network algorithm.

An example apparatus includes means for receiving a request from a radio access network algorithm to determine whether there is a distribution shift related to at least one temporal characteristic of at least one cell of a communication network; means for requesting data from a radio access network node or a controller platform related to the at least one temporal characteristic of the at least one cell, based on the request from the radio access network algorithm; means for receiving the requested data related to the at least one cell from the radio access network node or the controller platform; means for determining whether there is a distribution shift related to the at least one temporal characteristic of the at least one cell, based on the received data; means for, in response to determining that there is a distribution shift, selecting a learning type for an update to a model; and means for, based on the selected learning type, updating the model such that, when the model is provided to an inference server, causes the radio access network algorithm to use the updated model to perform at least one action to optimize the performance of the radio access network node or at least one other radio access network node.

An example apparatus includes means for receiving a request for data related to at least one temporal characteristic of at least one cell of a communication network from a radio intelligent controller; and means for providing the requested data from a radio access network node or a controller platform related to the at least one cell to the radio intelligent controller; wherein the provided data is configured to be used in a determination of whether to update a model associated with an action of the radio access network node or at least one other radio access network node.

An example apparatus includes means for sending a request from a radio access network algorithm, the request related to a determination of whether there is a distribution shift related to at least one temporal characteristic of at least one cell of a communication network; and means for performing at least one action using a model that has been updated to optimize the performance of a radio access network node or at least one other radio access network node, in response a determination that there is a distribution shift related to the at least one temporal characteristic of the at least one cell of the communication network.

An example method includes receiving a request from a radio access network algorithm to determine whether there is a distribution shift related to at least one temporal characteristic of at least one cell of a communication network; requesting data from a radio access network node or a controller platform related to the at least one temporal characteristic of the at least one cell, based on the request from the radio access network algorithm; receiving the requested data related to the at least one cell from the radio access network node or the controller platform; determining whether there is a distribution shift related to the at least one temporal characteristic of the at least one cell, based on the received data; in response to determining that there is a distribution shift, selecting a learning type for an update to a model; and based on the selected learning type, updating the model such that, when the model is provided to an inference server, causes the radio access network algorithm to use the updated model to perform at least one action to optimize the performance of the radio access network node or at least one other radio access network node.

An example method includes receiving a request for data related to at least one temporal characteristic of at least one cell of a communication network from a radio intelligent controller; and providing the requested data from a radio access network node or a controller platform related to the at least one cell to the radio intelligent controller; wherein the provided data is configured to be used in a determination of whether to update a model associated with an action of the radio access network node or at least one other radio access network node.

An example method includes sending a request from a radio access network algorithm, the request related to a determination of whether there is a distribution shift related to at least one temporal characteristic of at least one cell of a communication network; and performing at least one action using a model that has been updated to optimize the performance of a radio access network node or at least one other radio access network node, in response a determination that there is a distribution shift related to the at least one temporal characteristic of the at least one cell of the communication network.

An example non-transitory program storage device readable by a machine, tangibly embodying a program of instructions executable by the machine for performing operations is provided, the operations comprising: receiving a request from a radio access network algorithm to determine whether there is a distribution shift related to at least one temporal characteristic of at least one cell of a communication network; requesting data from a radio access network node or a controller platform related to the at least one temporal characteristic of the at least one cell, based on the request from the radio access network algorithm; receiving the requested data related to the at least one cell from the radio access network node or the controller platform; determining whether there is a distribution shift related to the at least one temporal characteristic of the at least one cell, based on the received data; in response to determining that there is a distribution shift, selecting a learning type for an update to a model; and based on the selected learning type, updating the model such that, when the model is provided to an inference server, causes the radio access network algorithm to use the updated model to perform at least one action to optimize the performance of the radio access network node or at least one other radio access network node.

An example non-transitory program storage device readable by a machine, tangibly embodying a program of instructions executable by the machine for performing operations is provided, the operations comprising: receiving a request for data related to at least one temporal characteristic of at least one cell of a communication network from a radio intelligent controller; and providing the requested data from a radio access network node or a controller platform related to the at least one cell to the radio intelligent controller; wherein the provided data is configured to be used in a determination of whether to update a model associated with an action of the radio access network node or at least one other radio access network node.

A non-transitory program storage device readable by a machine, tangibly embodying a program of instructions executable by the machine for performing operations is provided, the operations comprising: sending a request from a radio access network algorithm, the request related to a determination of whether there is a distribution shift related to at least one temporal characteristic of at least one cell of a communication network; and performing at least one action using a model that has been updated to optimize the performance of a radio access network node or at least one other radio access network node, in response a determination that there is a distribution shift related to the at least one temporal characteristic of the at least one cell of the communication network.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
4G fourth generation
5G fifth generation
5GC 5G core network
A1 interface between ONAP and RIC, or reference point between non-RT RIC and near-RT RIC in oRAN
AI artificial intelligence
AMF access and mobility management function
API application programming interface
API X another term for the C1 interface, or RIC
ASIC application-specific integrated circuit
B1 E2 reference point in xRAN
C1 interface between a RAN algorithm and the controller platform
CA carrier aggregation
CPU central processing unit
CQI channel quality indicator
CU central unit or centralized unit
CU-CP central unit control plane
CU-UP central unit user plane
DL downlink
DSL distribution shift learning
DSLM distribution shift learning module
DSP digital signal processor
DU distributed unit
eNB evolved Node B (e.g., an LTE base station)
E2 reference point (in ORAN) between the RIC near-RT and the RAN node
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 control interface between CU and DU
FPGA field-programmable gate array
GAN generative adversarial network
gNB base station for 5G/NR, i.e., a node providing NR user plane and control plane protocol terminations towards the UE, and connected via the NG interface to the 5GC
ID identifier
I/F interface
I/O input/output
KL Kullback Leibler
KPI key performance indicator
LMF location management function
LSTM long short-term memory
LTE long term evolution (4G)
MAC medium access control
ML machine learning
MLP multilayer perceptron
MME mobility management entity
NCE network control element
NE network element
ng or NG new generation
ng-eNB new generation eNB
NG-RAN new generation radio access network
NN neural network
NR new radio (5G)
N/W network
O1 interface to provide operation and management of CU, DU, RU, and near-RT RIC to the SMO
ONAP open networking automation platform
oRAN open radio access network
PDCCH physical downlink control channel
PDCP packet data convergence protocol
PHY physical layer
PRB physical resource block
PUCCH physical uplink control channel
RAN radio access network
RIC radio intelligent controller
RLC radio link control
RRC radio resource control (protocol)
RRH remote radio head
RRM radio resource management
RT real-time
RU radio unit
Rx receiver or reception
S-cell or Scell secondary cell
SDAP service data adaptation protocol
SGW serving gateway
SINR signal to interference noise ratio
SMO service management and orchestration
TRP transmission and reception point
TS technical specification
Tx transmitter or transmission
UE user equipment (e.g., a wireless, typically mobile device)
UL uplink
UPF user plane function
Xn Xn network interface
xRAN extensible radio access network

1-59. (canceled)

60. An apparatus comprising:
at least one processor; and
at least one non-transitory memory including computer program code;
wherein the at least one memory and the computer program code are configured to, with the at least one processor, cause the apparatus at least to:
send a request from a radio access network algorithm, the request related to a determination of whether there is a distribution shift related to at least one temporal characteristic of at least one cell of a communication network; and
perform at least one action using a model that has been updated to optimize the performance of a radio access network node or at least one other radio access network node, in response a determination that there is a distribution shift related to the at least one temporal characteristic of the at least one cell of the communication network.

61. The apparatus of claim 60, wherein the at least one action comprises at least one of:
an update to a channel quality indicator reporting interval for at least one user of the radio access network node or the at least one other radio access network node;
a modification to at least one measurement offset for the at least one user of the radio access network node or the at least one other radio access network node that changes at least one signal level at which a handover is triggered;
a change to an admission control threshold for the at least one user of the radio access network node or the at least one other radio access network node; or
a change to a carrier aggregation threshold for the at least one user of the radio access network node or the at least one other radio access network node.

62. The apparatus of claim 60, wherein the at least one memory and the computer program code are further configured to, with the at least one processor, cause the apparatus at least to:
provide, via an application programming interface, a formula/function of a key performance indicator among predefined choices from the radio access network algorithm; and
provide, via the application programming interface, at least one additional attribute describing characteristics of the distribution shift determination or model update.

63. The apparatus of claim 62, wherein the at least one additional attribute comprises at least one of:
a threshold of an evaluation of the formula/function of the key performance indicator over which the distribution shift is determined and model updated;
a type of characteristic based on which the distribution shift is determined, the type of characteristic comprising at least one of an average, a maximum, a given percentile for a confidence interval, a trend, a peak to average ratio, or a standard deviation and higher moment;
a list of underlying input key performance indicators of the model, the underlying input key performance indicators comprising at least one of a number of connected users, a number of active users, a number of bearers, downlink or uplink physical resource block utilization, physical downlink control channel utilization, physical uplink control channel utilization, composite available capacity, or total data delivered or received at the radio access network node;
a complexity constraint measure denoting how often the model can be updated;
a data storage constraint measure denoting how much data can be stored for updating the model; or
a preference for a passive learning model update or an active learning model update, wherein the passive learning model update comprises continuous learning without drift detection, and wherein the active learning model update is based on a characteristic of the determined distribution shift.

64. The apparatus of claim 60, wherein an interaction between a distribution shift learning module and the radio access network algorithm is facilitated with a controller platform.

65. The apparatus of claim 60, wherein:
the request from the radio access network algorithm comprises a function/formula performance metric of the model, the function/formula performance metric of the model being at least one of different error percentiles, mean error, or absolute error;
wherein the function/formula performance metric measures across different classes along with corresponding importance; and
the request from the radio access network algorithm includes a minimum performance expected from the model.

66. The apparatus of claim 60, wherein the at least one memory and the computer program code are further configured to, with the at least one processor, cause the apparatus at least to:
receive an indication that there is an update to the model, in response to there being a distribution shift and model update.

67. The apparatus of claim 60, wherein the at least one memory and the computer program code are further configured to, with the at least one processor, cause the apparatus at least to:
provide feedback from the radio access network algorithm related to the performance of the updated model to an intelligent controller.

68. The apparatus of claim 60, wherein the model is a machine learning or artificial intelligence model.

69. The apparatus of claim 60, wherein the apparatus implements the radio access network algorithm.

70. A method comprising:
sending a request from a radio access network algorithm, the request related to a determination of whether there is a distribution shift related to at least one temporal characteristic of at least one cell of a communication network; and
performing at least one action using a model that has been updated to optimize the performance of a radio access network node or at least one other radio access network node, in response a determination that there is a distribution shift related to the at least one temporal characteristic of the at least one cell of the communication network.

71. The method of claim 70, wherein the at least one action comprises at least one of:
an update to a channel quality indicator reporting interval for at least one user of the radio access network node or the at least one other radio access network node;
a modification to at least one measurement offset for the at least one user of the radio access network node or the at least one other radio access network node that changes at least one signal level at which a handover is triggered;
a change to an admission control threshold for the at least one user of the radio access network node or the at least one other radio access network node; or
a change to a carrier aggregation threshold for the at least one user of the radio access network node or the at least one other radio access network node.

72. The method of claim 70, further comprising:
providing, via an application programming interface, a formula/function of a key performance indicator among predefined choices from the radio access network algorithm; and
providing, via the application programming interface, at least one additional attribute describing characteristics of the distribution shift determination or model update.

73. The method of claim 72, wherein the at least one additional attribute comprises at least one of:
a threshold of an evaluation of the formula/function of the key performance indicator over which the distribution shift is determined and model updated;
a type of characteristic based on which the distribution shift is determined, the type of characteristic comprising at least one of an average, a maximum, a given percentile for a confidence interval, a trend, a peak to average ratio, or a standard deviation and higher moment;
a list of underlying input key performance indicators of the model, the underlying input key performance indicators comprising at least one of a number of connected users, a number of active users, a number of bearers, downlink or uplink physical resource block utilization, physical downlink control channel utilization, physical uplink control channel utilization, composite available capacity, or total data delivered or received at the radio access network node;
a complexity constraint measure denoting how often the model can be updated;
a data storage constraint measure denoting how much data can be stored for updating the model; or
a preference for a passive learning model update or an active learning model update, wherein the passive learning model update comprises continuous learning without drift detection, and wherein the active learning model update is based on a characteristic of the determined distribution shift.

74. A non-transitory program storage device readable by a machine, tangibly embodying a program of instructions executable by the machine for performing operations, the operations comprising:
sending a request from a radio access network algorithm, the request related to a determination of whether there is a distribution shift related to at least one temporal characteristic of at least one cell of a communication network; and
performing at least one action using a model that has been updated to optimize the performance of a radio access network node or at least one other radio access network node, in response a determination that there is a distribution shift related to the at least one temporal characteristic of the at least one cell of the communication network.
